(19) United States
(12) Patent Application Publication
(10) Pub. No.: US 2007/0156337 A1
(43) Pub. Date: Jul. 5, 2007

(54) Systems, methods and apparatuses for continuous in-vehicle and pedestrian navigation

(76) Inventor: Mamdouh Yanni, Markham (CA)

Correspondence Address: SUTHERLAND ASBILL & BRENNAN LLP, 999 PEACHTREE STREET, N.E., ATLANTA, GA, 30309, US

(21) Appl. No.: 11/356,271

(22) Filed: Feb. 15, 2006

Related U.S. Application Data
(60) Provisional application No. 60/755,133, filed on Dec. 30, 2005.

(51) Int. Cl. G01C 21/00

(52) U.S. Cl. 701/213

(57) ABSTRACT

Accelerometers are used to provide acceleration data in 3 dimensions, from which vehicle distance traveled may be calculated during GPS outage using a one step integration of a 3-D pseudo acceleration vector. Magnetometers may also be used in combination with the accelerometers to calculate direction of travel. The system may be utilized for combined in-vehicle navigation and pedestrian navigation applications, and the same hardware is utilized for both system applications.

### RELATED APPLICATION DATA

The present application claims priority to U.S. Provisional Patent Application Ser. No. 60/755,133, filed Dec. 30, 2005, titled “Systems, Methods and Apparatuses for Continuous In-Vehicle and Pedestrian Navigation”, the entire contents of which are incorporated herein by reference as if set forth fully herein.

### FIELD OF THE INVENTION

The present invention relates generally to dead-reckoning systems, and more particularly, to systems, apparatuses, methods, and computer program products that enable continuous navigation of a person or vehicle without requiring GPS signals.

### BACKGROUND OF THE INVENTION

Navigation electromagnetic waves such as those transmitted by GPS and GLONASS satellites may be interrupted or affected by multi-path in urban canyons, suburban or wooded environments, and the like. They may also be unavailable due to external forces such as bad weather conditions or signal interference. Furthermore, optimal antenna positioning is not always possible in enabling a good reception of signals from such systems.

In order to remedy these limitations, dead-reckoning systems (DRS)/inertial navigation systems (INS) are necessary. However, conventional DRS and INS are inaccurate and a single system may not be utilized by both vehicles and pedestrians for navigation. They may also require user interaction, such as pedestrian height input or a step length information input during a set-up procedure, as is common in pedestrian navigation systems.

Therefore, what is desirable is a device, method, and/or computer program product that permits seamless, continuous navigation for both vehicles and pedestrians regardless of the GPS status. It would also be desirable if the device, method, and/or computer program product did not require user interaction (other than carrying the system hardware) to ensure accurate navigation.

### SUMMARY OF THE INVENTION

According to an embodiment of the invention, there is disclosed a Destinator Continuous Navigation (DCN) module that includes an accelerometer, such as a 3-D MEM (Micro-Electro-Mechanical) accelerometer, to calculate vehicle and pedestrian distance traveled during GPS signal outages. A 3-D magnetometer may also be incorporated into the DCN module, as well as an altimeter and/or temperature sensor. The DCN module does not interface to the vehicle or a pedestrian in any way other than mechanically (e.g., being mounted in a vehicle, placed on the dash board of the vehicle, or carried by a pedestrian or placed on the pedestrian's back). The utilization of GPS together with these inertial navigation sensors will allow seamless, continuous navigation regardless of the GPS status.

According to another aspect of the invention, the DCN module may be used for both in-vehicle and pedestrian navigation. Therefore, different portable hardware and/or digital signal processing software is not required to effect different navigation uses (i.e., in-vehicle or pedestrian navigation). According to yet another aspect of the invention, MEMs accelerometers employed are effectively utilized as a microphone to extract the vehicle (or pedestrian) velocity noise vector, termed in this document as the 3-D acceleration vector or 3-D pseudo-acceleration vector. The present invention includes a 1-step integration method to extract vehicle (or pedestrian) distance from MEMs accelerometer sensor readings, which simplifies and minimizes the processing required to determine distance traveled without a GPS signal. According to another aspect of the invention, no step calculations are required to permit pedestrian navigation, thereby simplifying use of the device by a consumer.

According to an embodiment of the invention, there is disclosed a method of providing continuous navigation. The method includes identifying the last known location of an object using, at least in part, a GPS signal, and estimating a distance travelled by the object from the last known location using only information received from an accelerometer located on a device positioned on the object, where estimating the distance is based on a single integration of a three dimensional acceleration vector derived from the accelerometer, and where the device is positioned on the object, but receives no other electrical or mechanical inputs from the object.

According to one aspect of the invention, the object is a vehicle or a pedestrian. According to another aspect of the invention, the method includes determining a next location of the object based on information received from the accelerometer and a magnetometer of the device. The method can also include estimating a heading of the object based on a magnetometer located on the device positioned on the object. According to yet another aspect of the invention, the method includes conducting tilt measurements on the accelerometer when the object is not moving.

According to yet another aspect of the invention, the method may include normalizing three dimensional data received from the accelerometer, prior to estimating the distance travelled by the object, to generate normalized three dimensional data. Normalizing the three dimensional data received from the accelerometer may include using quaternion rotation calculations to generate the normalized three dimensional data, and/or include using tilt measurements of the accelerometer to generate the normalized three dimensional data. Additionally, the three dimensional acceleration vector derived from the accelerometer may be generated from the normalized three dimensional data.

The method may also include filtering the three dimensional acceleration vector derived from the accelerometer prior to the single integration of a three dimensional acceleration vector. Additionally, the method can include determining if the object is moving by filtering the three dimensional acceleration vector. According to another aspect of the invention, the method also includes determining whether global positioning system (GPS) signals are available subsequent to estimating a distance travelled by the object. Moreover, the method can include calculating regression, when GPS signals are available, between the estimated distance travelled by the object and an estimated GPS distance travelled determined from the GPS signals. According to another aspect of the invention, a computer-readable medium having stored thereon computer-executable instructions may perform the methods described above.

According to another embodiment of the present invention, there is disclosed a device, positioned on an object, for providing continuous navigation. The device includes an accelerometer and at least one computer program operable to identify the last known location of the object using, at least in part, a GPS signal, and estimate a distance travelled by the object from the last known location using only information received from the accelerometer, where estimating the distance is based on a single integration of a three dimensional acceleration vector derived from the accelerometer. Additionally, the device is positioned on the object, but receives no other electrical or mechanical inputs from the object.

According to an aspect of the invention, the object is a vehicle or a pedestrian. According to another aspect, the device further includes a magnetometer, and the at least one computer program is operable to determine a next location of the object based on information received from the accelerometer and a magnetometer of the device. According to yet another aspect of the invention, the device includes a magnetometer, and the at least one computer program is further operable to estimate a heading of the object.

The at least one computer program can also be operable to conduct tilt measurements on the accelerometer when the object is not moving, and/or can normalize three dimensional data received from the accelerometer, prior to estimating the distance travelled by the object, to generate normalized three dimensional data. The at least one computer program may normalize the three dimensional data using quaternion rotation calculations and/or using tilt measurements. Further, the at least one computer program may be operable to generate the three dimensional acceleration vector, derived from the accelerometer, from the normalized three dimensional data.

According to another aspect of the invention, the at least one computer program may filter the three dimensional acceleration vector derived from the accelerometer prior to the single integration of a three dimensional acceleration vector. According to yet another aspect of the invention, the at least one computer program can determine if the object is moving by filtering the three dimensional acceleration vector.

The at least one computer program is further operable to determine whether global positioning system (GPS) signals are available subsequent to estimating a distance travelled by the object. Moreover, the at least one computer program can calculate regression, when GPS signals are available, between the estimated distance traveled by the object and an estimated GPS distance traveled determined from the GPS signals.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1a shows an exemplary DCN module, according to an illustrative embodiment of the present invention.

FIG. 1b shows an exemplary device incorporating a DCN module, according to an illustrative embodiment of the present invention.

FIG. 1c shows a system including an exemplary GPS device in communication with a DCN module, according to an illustrative embodiment of the present invention.

FIGS. 2a and 2b illustrate, in block diagram form, a high level process flow implemented by a DCN module according to an illustrative embodiment of the present invention.

FIG. 3 shows a top-level mathematical model of a DCN module, according to an illustrative embodiment of the present invention.

FIG. 4 shows an accelerometer normalization module, according to an illustrative aspect of the present invention.

FIG. 5a shows an accelerometer normalization calculation, according to an illustrative aspect of the present invention.

FIG. 5b shows a graphical interface for adjusting upper and lower saturation values, according to an illustrative aspect of the present invention.

FIG. 6 shows a 2-Dimensional tilt calculation module, according to an illustrative aspect of the present invention.

FIG. 7 shows, in model form, the equations governing system tilt definitions, according to an illustrative aspect of the present invention.

FIG. 8 shows a quaternion rotation normalization module, according to an illustrative aspect of the present invention.

FIG. 9 shows a quaternion z-axis rotation computation module, according to an illustrative aspect of the present invention.

FIG. 10 shows a quaternion rotation axis module, according to an illustrative aspect of the present invention.

FIG. 11 shows a quaternion inverse generation module, according to an illustrative aspect of the present invention.

FIG. 12a shows a vector dot product computation, according to an illustrative aspect of the present invention.

FIG. 12b shows a vector cross product computation, according to an illustrative aspect of the present invention.

FIG. 13 shows an offset normalization module, according to an illustrative aspect of the present invention.

FIG. 14a shows the computation of a mean of an electronically gimbaled 3-D accelerometer amplitudes, according to an illustrative aspect of the present invention.

FIG. 14b shows the construction of a composite 3-D pseudo acceleration vector, according to an illustrative aspect of the present invention.

FIG. 15 shows a low pass digital filter for filtering the 3-D pseudo acceleration vector of FIG. 14b, according to an illustrative aspect of the present invention.

FIG. 16 shows a DCN distance module, according to an illustrative aspect of the present invention.

FIG. 17 shows a velocity calculation enable module according to an illustrative aspect of the present invention.

FIG. 18a shows a digital filter transfer function for filtering the 3-D pseudo acceleration vector as used in the velocity calculation enable module of FIG. 17, according to an illustrative aspect of the present invention.

FIG. 18b shows a check range module used in the velocity calculation enable module of FIG. 17, according to an illustrative aspect of the present invention.

FIG. 19 shows a vehicle distance calculation module, according to an illustrative aspect of the present invention.

FIG. 20a shows a “DCN raw distance integration control (CTRL)” module of the vehicle distance calculation module of FIG. 19, according to an illustrative aspect of the present invention.

FIG. 20b shows a “DCN distance calculation during GPS fix” module of the vehicle distance calculation module of FIG. 19, according to an illustrative aspect of the present invention.

FIG. 20c shows a “DCN distance calculation during GPS outage” module of the vehicle distance calculation module of FIG. 19, according to an illustrative aspect of the present invention.

FIG. 21 shows a “DCN multiplier calibration” module, according to an illustrative aspect of the present invention.

FIG. 22 shows a “DCN distance (GPS lost)” module, according to an illustrative aspect of the present invention.

FIG. 23 shows a regression calculation (GF) module, according to an illustrative aspect of the present invention.

FIG. 24 shows a regression correlation module, according to an illustrative aspect of the present invention.

FIGS. 25a-25b show mathematical implementations of slope and intercept equations, respectively, according to an illustrative aspect of the present invention.

FIG. 26 shows a DCN multiplier calculation module, according to an illustrative aspect of the present invention.

FIG. 27 shows a magnetometer normalization module, according to an illustrative aspect of the present invention.

FIG. 28 shows a magnetic field anomaly detection module, according to an illustrative aspect of the present invention.

FIG. 29a shows an earth magnetic field module, according to an illustrative aspect of the present invention.

FIG. 29b shows a magnetic field mean module, according to an illustrative aspect of the present invention.

FIG. 30 shows a full magnetometer calibration module, according to an illustrative aspect of the present invention.

FIGS. 31a-31b show hard iron modules for “hard iron” calibration, according to an illustrative aspect of the present invention.

FIG. 32 shows a soft iron calibration module, according to an illustrative aspect of the present invention.

FIGS. 33a-33b show, respectively, an ‘if’ statement definition and an ‘else’ statement definition implemented by the soft iron calibration module of FIG. 32, according to an illustrative aspect of the present invention.

FIG. 34a a shows a non-orthogonality calibration module, according to an illustrative aspect of the present invention.

FIG. 34b a shows a orthogonality correction module, according to an illustrative aspect of the present invention.

FIG. 35a shows magnetometer bearing normalization module, according to an illustrative aspect of the present invention.

FIG. 35b shows a soft iron “atan2” calculation by the soft iron calibration module of FIG. 32, according to an illustrative aspect of the present invention.

FIG. 36 shows an azimuth angular definition used by the soft iron calibration module of FIG. 32, according to an illustrative aspect of the present invention.

FIG. 37 shows a magnetic declination correction module of the DCN module of FIG. 3, according to an illustrative aspect of the present invention.

FIG. 38 shows a combined DCN/GPS distance module of the DCN module of FIG. 3, according to an illustrative aspect of the present invention.

FIG. 39 shows a definition implemented by the latitude/longitude given radial and distance module of the DCN module of FIG. 3, according to an illustrative aspect of the present invention.

FIG. 40 shows a GPS/DCN initial location module of the DCN module of FIG. 3, according to an illustrative aspect of the present invention.

### DETAILED DESCRIPTION OF THE PRESENT INVENTIONS

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

It will be appreciated that the present invention is described below with reference to block diagrams illustrations of methods, apparatuses, systems and computer program products according to an embodiment of the invention. It will be understood that each block of the block diagrams and combinations of blocks in the block diagrams, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the block diagrams.

These computer program instructions may also be stored in a computer-readable memory that can direct a computer or other programmable data processing apparatus to function in a particular manner, such that the instructions stored in the computer-readable memory produce an article of manufacture including instruction means that implement the function(s) specified in the diagrams. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the diagrams.

Accordingly, blocks of the block diagrams support combinations of means for performing the specified functions, combinations of steps for performing the specified functions and program instruction means for performing the specified functions. It will also be understood that each block of the block diagrams, and combinations of blocks in the block diagrams, can be implemented by hardware-based computer systems that perform the specified functions or steps, or combinations of hardware and computer instructions.

A DCN module of the present invention can be utilized in conjunction with a GPS system such that the DCN module may immediately provide navigation to vehicles and pedestrians, or the like when a GPS signal is lost. The DCN module utilizes the last known GPS location as a starting point for navigation, after which the DCN module does not rely on any additional signals or inputs (other than those internal to the DCN module) to provide continuous navigation. According to one aspect of the invention, the DCN module may be a device removably affixed to vehicles and persons to permit continuous navigation without requiring any electrical or mechanical interface (other than being mounted in a vehicle or carried by a pedestrian).

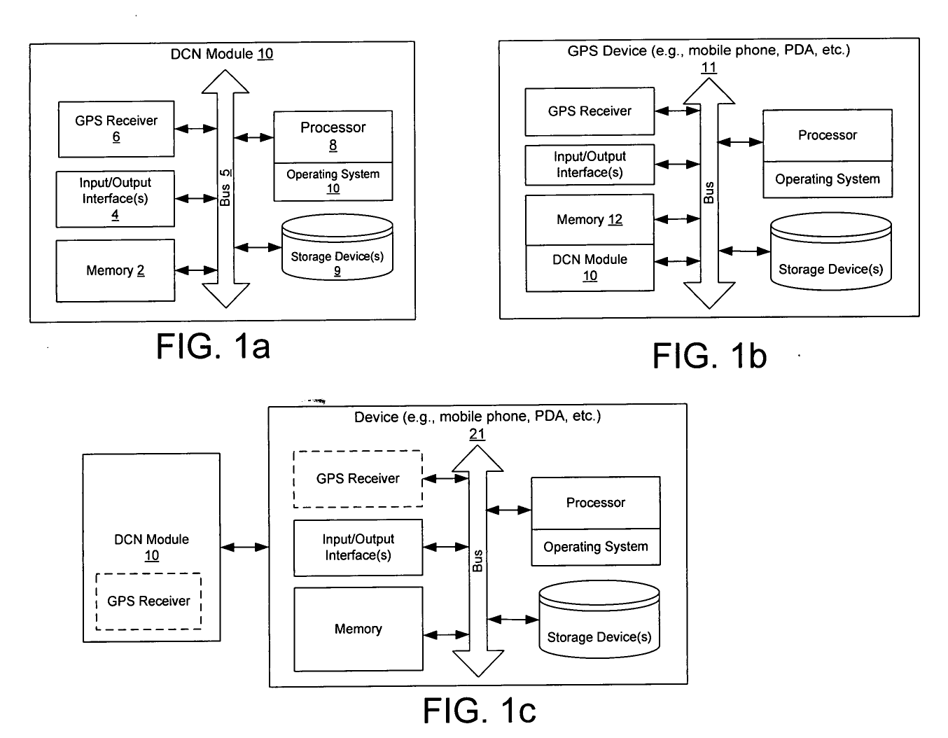

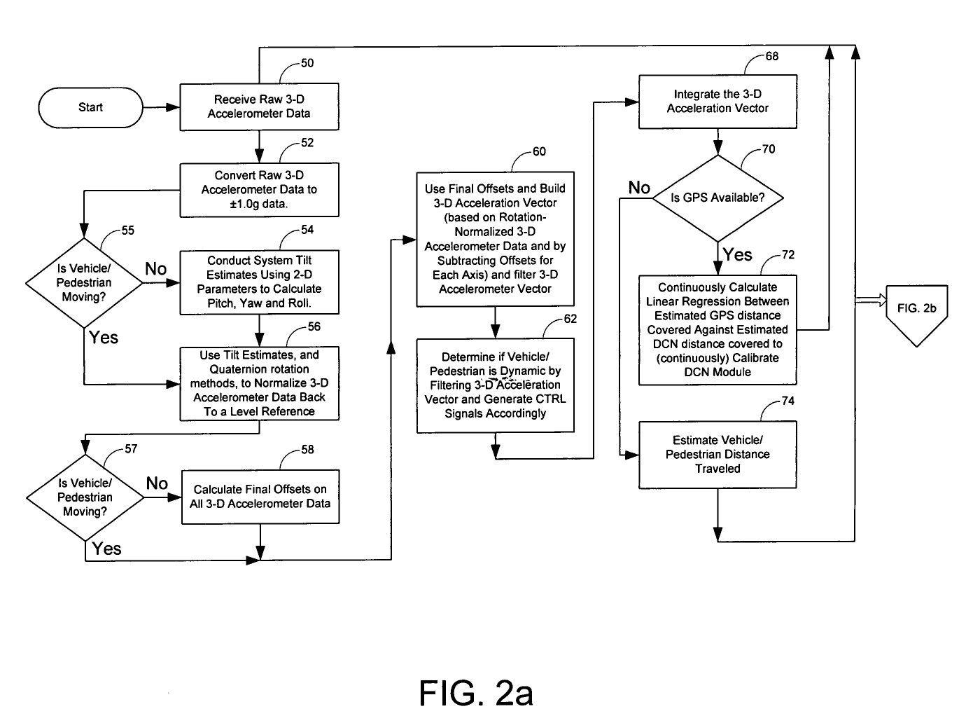

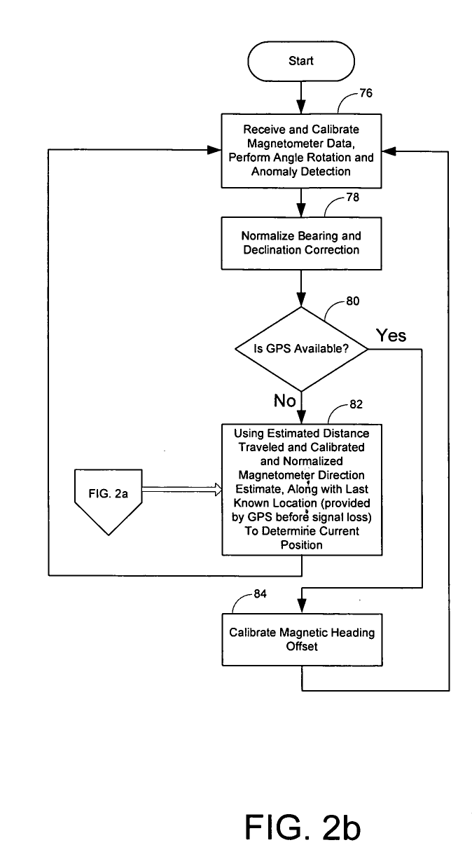

FIG. 1a shows a DCN module 1 according to an illustrative embodiment of the invention. The DCN module 1 of FIG. 1 includes a processor 8, operating system 10, bus 5, input/output interface(s) 4, GPS receiver 6, and one or more storage devices 9, and a memory 2. The bus 5 includes data and address bus lines to facilitate communication between the processor 8, operating system 10 and the other components within the DCN module 1, including the memory 2 and the storage device(s) 9. The processor 8 executes the operating system 10, and together the processor 8 and operating system 10 are operable to execute functions implemented by the DCN module 1, including executing software applications and/or algorithms stored in the memory 2. The software applications and/or algorithms may utilize and/or rely on data stored in the one or more storage device(s) 9 to implement the functions described herein with respect to FIGS. 2-40. Data obtained from an accelerometer (not illustrated) and magnetometer (not illustrated) within the DCN module 1 is also used by the software applications and/or algorithms to calculate distance traveled and direction traveled, respectively, when GPS is not available.

The DCN module 1 shown in FIG. 1 also includes a Global Positioning System (GPS) receiver. The GPS, as is known in the art, is a series of 24 geosynchronous satellites that continuously transmit their position and are used in personal tracking, navigation and automatic vehicle location technologies. As explained in detail below, a DCN module of the present invention is operable to determine the location of the DCN module using GPS signals and after GPS signals are lost, thereby allowing a vehicle or pedestrian continuous navigation in all locations. To effect such navigation, the DCN module 1 can use the last known position of the DCN module 1 as a starting point for determining the location of the DCN module 1 after GPS signals are lost.

It should be appreciated that although the DCN module 1 of FIG. 1a includes a memory 2 and storage device(s) 9 operating in conjunction with a processor 8 and operating system 10, a DCN module of the present invention may include a combination of software and hardware, or only hardware. For instance, the processor and operating system may be replaced by one or more dedicated application specific integrated circuits (ASICs), or the like, for achieving the functions described herein. Furthermore, the entire DCN module 1 may be implemented by one or more ASICs. It will also be appreciated that a DCN module of the present invention may be implemented on any hardware platform using any operating system.

According to an embodiment of the invention, the DCN module 10 may reside within a GPS-enabled device 11, such as a GPS-enabled mobile phone, GPS receiver, PDA, PNA's/PND, or the like, as is shown in FIG. 1b. According to one aspect of the invention, the DCN module 10 may include computer program products stored within a memory 12 of the device 11 that utilize components within the GPS-enabled device 11 to operate, such as a processor 18, operating system 20, GPS receiver 16, input/output interface(s) 14, and data received from an accelerometer (not illustrated) and magnetometer (not illustrated). As is also shown in the illustrative embodiment of FIG. 1c, a DCN module 11 of the present invention may also utilize one or more components of a device 21 in communication with the DCN module 11 to operate. As illustrated in FIG. 1c, the DCN module may include a GPS receiver such that the DCN module 11 does not receive GPS data from a GPS receiver within the device 21. However, the device 21 may include a GPS receiver, which may be used by the DCN module 11 if the DCN module 11 does not include a GPS receiver.

It will be appreciated that the illustrative embodiments shown in FIGS. 1a-1c are illustrative, and that any combination of hardware and/or software may be used to implement a DCN module of the present invention. As such, one or more of the components illustrated in FIGS. 1a-1c may be distributed and/or combined to effect the functions described herein.

Next, FIGS. 2a and 2b show a high level process flow implemented by a DCN module of the present invention to determine the location of a person, vehicle, or the like when GPS signals are lost. Initially, the DCN module receives raw 3-D accelerometer data (block 50) from an accelerometer carried by a vehicle/pedestrian. The DCN module then converts the raw 3-D accelerometer data to ±1.0 g data (block 52). When the vehicle/pedestrian is not moving (block 55), the DCN module conducts system tilt estimates using 2-D parameters to calculate pitch, yaw and roll (block 54). Once that occurs, or if the vehicle/pedestrian is moving (block 55), using tilt estimates and quaternion rotation methods, the DCN module normalizes the 3-D accelerometer data back to a level reference (block 56). This corrects for the position of the accelerometer on the vehicle/pedestrian. If the vehicle/pedestrian is not moving (block 57), the DCN module calculated final offsets (block 58) on all 3-D accelerometer data. Once that process occurs, or if the vehicle/pedestrian is moving (block 57), the DCN module uses final offsets and builds a 3-D acceleration vector based on rotation-normalized 3-D accelerometer data and by subtracting minor error offsets for each axis (block 60). The 3-D acceleration vector is also heavily filtered (block 60).

The DCN module then determines if the vehicle/pedestrian is dynamic by filtering the 3-D acceleration vector and generates control (CTRL) signals accordingly (block 62), as is explained in greater detail below with respect to a particular illustrative embodiment of the invention. Next, the 3-D acceleration vector is integrated (block 68) in a single integration step. If GPS is available (block 70), the DCN module continuously calculates linear regression between estimated GPS distance covered against estimated DCN distance covered to calibrate the DCN module (block 72). On the other hand, if GPS is not available (i.e., GPS is ‘lost’), the DCN module estimates the vehicle/pedestrian distance traveled (block 74). The estimated vehicle/distance traveled (block 74) is then utilized as an input as illustrated in FIG. 2b and used with heading information to determine the position of the DCN module.

As illustrated in FIG. 2b, simultaneously with the processing described with respect to FIG. 2a, magnetometer data is received and calibrated and angle rotation and anomaly detection is performed to identify and/or correct for potential errors in the magnetometer data (block 76). The bearing of the magnetometer (and hence the DCN module) is thereafter normalized, and declination correction is performed (block 78), as is described in detail below with respect to an illustrative embodiment of the invention. Declination (λ), as referenced herein, is the angle between geographic (true) North and magnetic North measured by the magnetometer. If GPS is not available (block 80), the estimated vehicle distance traveled is used, along with calibrated and normalized magnetometer direction estimates, and the last known location (provided by the GPS immediately after signal lost, or estimated continuously by the DCN thereafter), to determine the current position of the DCN module (block 82). If GPS is available (block 80), a magnetic heading offset is calibrated (block 84) and used to further identify and/or correct for errors in magnetometer data (block 76).

It will be appreciated that the above-described calculations may be implemented by any of the devices described above with respect to FIG. 1, as well as any combination of hardware and/or software receiving data from an accelerometer and magnetometer. Additionally, although described herein as including a magnetometer to identify location, it should be appreciated that the present invention could utilize only the processes described with respect to FIG. 2a to identify distance traveled where the direction of travel is not needed.

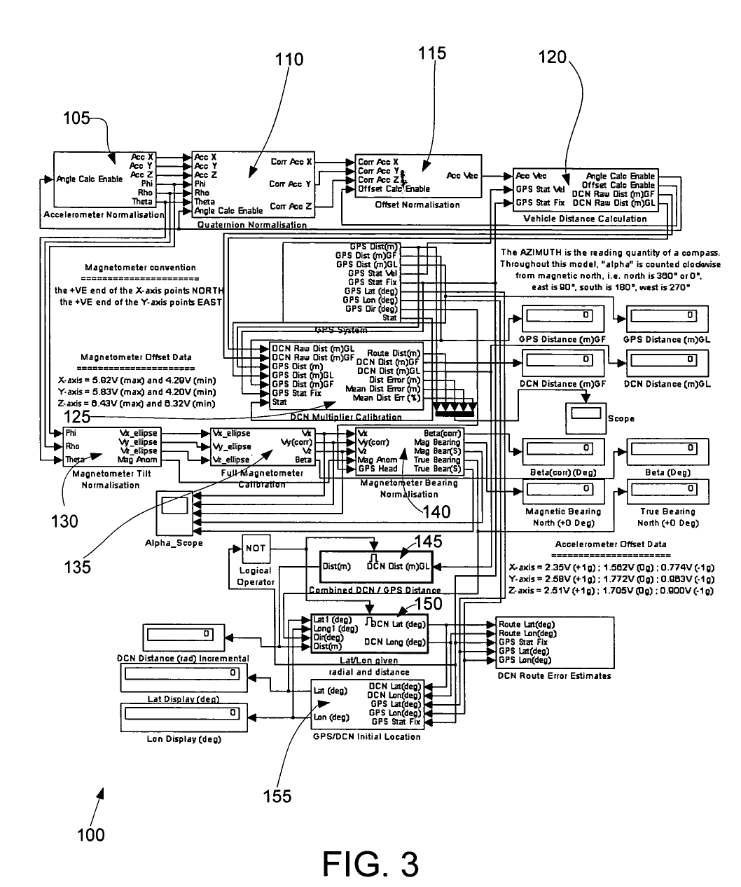

Next, an illustrative DCN module 100 is shown in FIG. 3 and discussed in detail with respect to FIGS. 3-40. In particular, FIG. 3 shows a top-level mathematical model of a DCN module 100 according to an illustrative embodiment of the present invention. The DCN module described hereinafter with respect to FIGS. 3-40 is described with respect to a Matlab mathematical representation of the DCN module 100, which describes the algorithms and processes that provide functionality to the DCN module 100. It will be appreciated that the mathematical model will represent calculations, processes, and/or methods that may be implemented via any software, hardware, and/or a combination thereof, as discussed in detail above. Thus, it will be appreciated that the DCN module 100 illustrated in FIG. 3 is merely an illustrative and non-limiting example of a DCN module according the present invention. As such, it should be appreciated that the present invention may be embodied in alternative forms.

FIG. 3 shows a DCN module 100 according to an illustrative embodiment of the present invention. The DCN module 100 includes an accelerometer normalization module 105, a quaternion normalization module 110, an offset normalization module 115, a vehicle distance calculation module 120, and a DCN multiplier calibration module 125. The purpose and functions of these modules 105, 110, 115, 120, 125 will first be described at a high level, and then considered separately in greater detail.

The accelerometer normalization module 105 is operable to receive real raw 3-D accelerometer data in voltage form from a 3-D accelerometer internal or local to the DCN module 100. Briefly, the accelerometer normalization module 105 receives the accelerometer data and converts it into ±1.0 g data. The accelerometer normalization module 105 also conducts system tilt estimates using 2-D parameters to calculate pitch, roll and yaw. As used herein, pitch (φ) is a tilt along the x-axis (or heading direction of the vehicle/pedestrian), which is a rotation around the y-axis. Additionally, roll (ρ) is a tilt along the y-axis, or equal to rotation around the heading direction (the x-axis). Finally, yaw is a rotation around the z-axis. According to an aspect of the invention, the tilt estimates are conducted only when the vehicle is not moving using the “Angle Calc Enable” input as a decision maker as to whether the vehicle is stationary.

Next, the quaternion normalization module 110 takes in the pitch, roll and yaw estimates from the accelerometer normalization module 105 and uses quaternion rotation methods, as are known in the art, to normalize the 3-D accelerometer data back to a level reference. The offset normalization module 115 then calculates final minor error offsets on all 3-D accelerometer axis. These offsets are then subtracted from the rotation normalized data before build of a 3-D acceleration vector (or a 3-D pseudo acceleration vector). This vector is then filtered using a low pass filter, such as a 2 Hz Infinite Response (IIR) digital Checbychev II filter.

The vehicle distance calculation module 120 is divided into two stages, as is described in greater detail below. The first stage takes in the 3-D acceleration vector and uses a Butterworth filter, such as a 0.5 Hz Infinite Impulse Response (IIR) digital Butterworth filter, to process the signal. A comparison is then conducted to make a decision if the vehicle is dynamic. This is reflected in the “Angle Calc Enable”, “Offset Calc Enable” and “Vel Calc Enable” signals. The “Angle Calc Enable” decides when to make system tilt calculations, and the “Offset Calc Enable” decides when to make system offset calculations. Finally, the “Vel Calc Enable” decides when to make integration calculations on the 3-D acceleration vector. The second stage of the vehicle distance calculation module 120 conducts the actual integration of the 3-D acceleration vector.

Next, the DCN multiplier calibration module 125 takes in GPS distance calibration data together with DCN raw distance data and conducts regression analysis. This allows the DCN module to fit the DCN raw distance (treated as X-axis) to the GPS reference distance (treated as Y-axis) using a straight line equation to give a “gradient” estimate, which is termed the “DCN Multiplier”. Finally, this multiplier is utilized together with the DCN raw distance to give “DCN Dist” estimates.

Also included in the DCN module are magnetometer normalization, calibration, and bearing normalization modules 130, 135, 140. The magnetometer normalization module 130 reads real raw 3-D magnetometer data in voltage form and converts to earth magnetic field voltage data. The 3-D magnetometer data is provided from a magnetometer internal or local to the DCN module 100. The magnetometer normalization module 130 also conducts magnetometer tilt correction using pitch, roll and yaw estimates provided by the accelerometer normalization module 105. Also, magnetic anomaly detection is conducted at this stage to allow true course measurement during external magnetic disturbances (i.e. external to the earth magnetic field).

The full magnetometer calibration module 135 allows calibration against “Soft Iron”, “Hard Iron” and “X, Y-axis Orthogonality Correction”. “Soft Iron” disturbances occur from ferrous material existent in the magnetometer's vicinity, while “Hard Iron” disturbances occur from magnetic material existent in the magnetometer's vicinity. Orthogonality effects exist due to faulty fabrication process of magnetometer axis at an angle not equal to 90°. Next, the magnetometer bearing normalization module 140 takes azimuth calculations from −180° to +180° and converts them into 0° to 360° angle calculations. Azimuth (α) is the angle between magnetic north and the heading direction, and is the azimuth is the reading quantity of a compass. Throughout the illustrative embodiment discussed with respect to FIGS. 3-40, azimuth is counted clockwise from magnetic north, i.e. north is 360° or 0°, east is 90°, south is 180°, west is 270°. The magnetometer bearing normalization module 140 also accounts for magnetic declination using Magnetic World Maps as model inputs. Declination is defined as “East” if magnetic North falls to the east of true North; and “West” if magnetic North falls to the West of true North. A positive declination is “East”, and a negative declination is “West”. Additionally, according to an aspect of the invention, when a GPS signal is available, the GPS heading may be used by the calibration module 135 to calibrate the heading of the magnetometer.

To integrate the DCN module with a GPS, a DCN distance module 145 performs piece-wise DCN distance calculations during GPS outages and provides this into great circle equations as input. During GPS outages, the latitude/longitude given radial and distance module 150 takes a source latitude, longitude, distance and direction and provides a target latitude and longitude. Finally, the GPS/DCN initial location module 155 ensures that when GPS outage is experienced, that the DCN module takes a good known GPS fix location as initial latitude and longitude coordinate point for subsequent DCN positional calculations.

I. Accelerometer-Related Calculations

As described above, according to one aspect of the invention, voltage may be read from a 3-D accelerometer. According to one aspect of the invention, the voltage may be read from a MMA7260Q 3-D accelerometer from Freescale Semiconductor™, although it will be appreciated that other 3-D accelerometers may be used in the DCN module 100. The accelerometer is initially calibrated such that the minimum and maximum read voltage in each dimension correspond to −1 g and +1 g, respectively. Additionally, voltage readings are measured while the accelerometer is at the zero G position to determine the voltage when the accelerometer is at rest. Illustrative readings from a particular 3-D accelerometer when its 3 axes are subjected to positive gravity (+1 g), negative gravity (−1 g), and zero G (0 g) are as follows:

X-Accelerometer range=2.48V (1 g); 1.67V (0 g); 0.89V (−1 g)

Y-Accelerometer range=2.59V (1 g); 1.80V (0 g); 0.98V (−1 g)

Z-Accelerometer range=2.40V (1 g); 1.61V (0 g); 0.81V (−1 g)

For the purposes of illustrating the methods of the present invention, the above values are utilized in the mathematical models shown in the figures. It will be appreciated, however, that these readings are illustrative only, and that the present invention may be implemented with different readings from other accelerometers. Indeed, the purposes of the calibration and normalization methods described herein ensure that the DCN module 100 is operable to provide accurate continuous navigation regardless of the particular 3-D accelerometer used to provide data to the accelerometer normalization module 105.

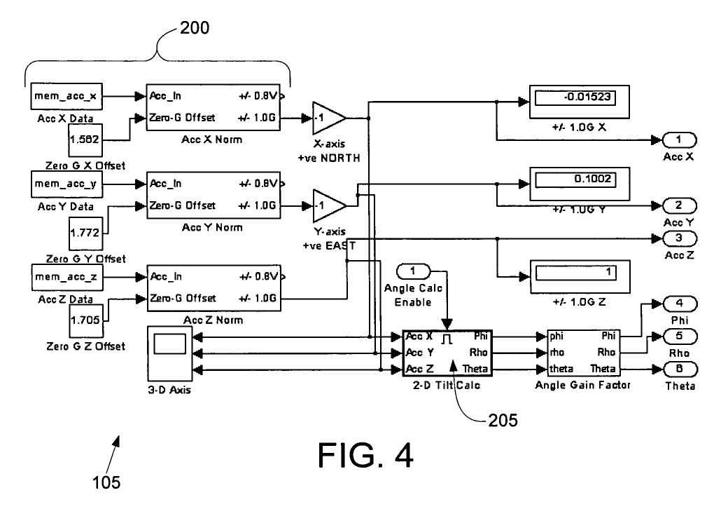

The above illustrative readings are incorporated into the accelerometer normalization module 105 to go from volts received from all 3-axes to limiting the range from +1 g to −1 g as recommended as the effective and highly accurate range in the accelerometer specification provided by the accelerometer manufacturer. Therefore, this range may vary based on the accelerometer used with (or in) the DCN module. More specifically, as shown in FIG. 4, the accelerometer normalization module 105 takes in real accelerometer data from the x-, y- and z-axis. This data is initially presented in voltage. It is then transformed from volts to a limited range of ±1.0 g. This step is applied all 3-D data, which may be received continuously from the accelerometer. According to one aspect of the invention, data is provided at 100 Hz from the accelerometer (i.e., X, Y, and Z data are sampled at 100 Hz) such that readings are taken many times per second. According to one aspect of the invention (not illustrated), the X, Y and Z-data may be averaged to account for road noise disturbance, for instance, which may result from pot holes and the like. That is, averaging the data may minimize the impact of short but extreme variances in accelerometer data. Other methods of averaging this data may be used, as are known in the art.

Also calculated in the accelerometer normalization module 105 is the overall tilt angle of the 3-D accelerometer. This incorporates a standard method for calculating pitch, roll and yaw angles of the system, and as such, will not be described further herein. Once these angles are calculated, they are passed on the next phase of the DCN mathematical model, the quaternion normalization module 110.

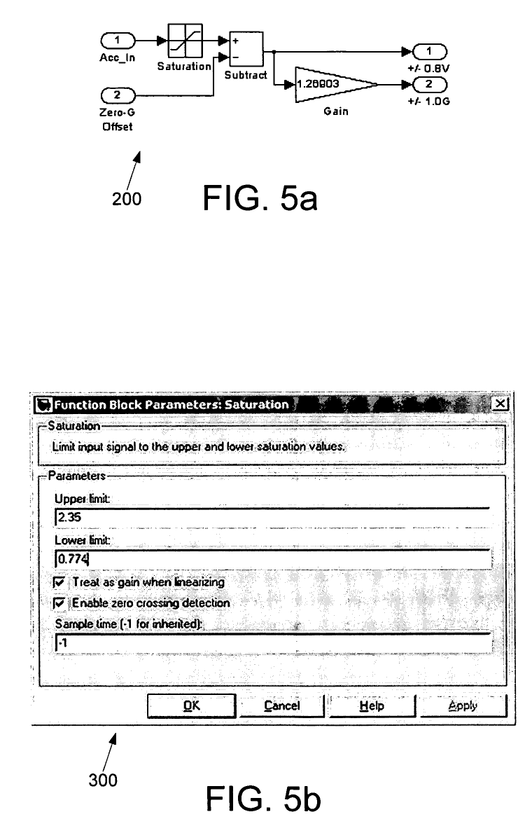

An accelerometer normalization calculation 200 for the X-axis is shown in FIG. 5a. In particular, the system zero-offsets the raw x-axis accelerometer data and converts it to a clipped data set of a maximum range of 1 g. Although only illustrated with respect to the X-axis, this is applied to all 3-D accelerometer axes. In particular, FIG. 5a shows an initial stage of subtracting the zero-G X-axis offset (“Zero-G Offset”) from the incoming X-axis data (“Acc_In”), limiting it to pre-calibrated ranges, as shown in FIG. 5a, and then converting from volts to Gs with a nominal value of 800 mV per G. As shown in FIG. 5b, the upper and lower saturation values may be manipulated via an input interface 300 to the DCN module.

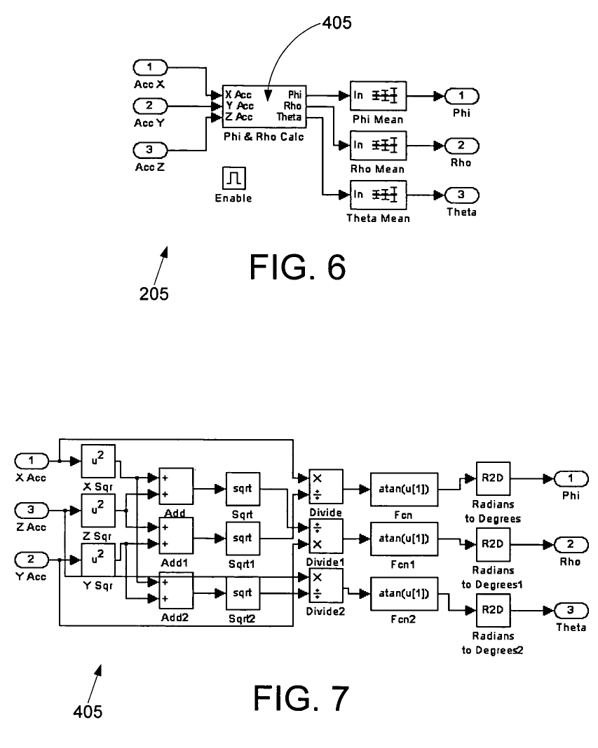

The 2-Dimensional tilt calculation module 205 shown in FIG. 6 utilizes all three accelerometer axes to calculate tilt angles for the complete system. These angles include pitch (“Phi”—rotation around the Y-axis), roll (“Rho”—rotation around the X-axis) and yaw (“Theta”—rotation around the Z-axis). These calculations are only conducted when the vehicle is not moving defined by the “Angle Calc Enable” signal. The equations governing system tilt definitions 405 are shown in model form in FIG. 7, and are as follows:

$$ϕ = {tan}^{- 1} ( \frac{{X}_{acc}}{\sqrt{{Y}_{acc}^{2} + {Z}_{acc}^{2}}} )$$

$$ρ = {tan}^{- 1} ( \frac{{Y}_{acc}}{\sqrt{{X}_{acc}^{2} + {Z}_{acc}^{2}}} )$$

$$and$$

$$θ = {tan}^{- 1} ( \frac{{Z}_{acc}}{\sqrt{{X}_{acc}^{2} + {Y}_{acc}^{2}}} )$$

II. Quaternion Normalization

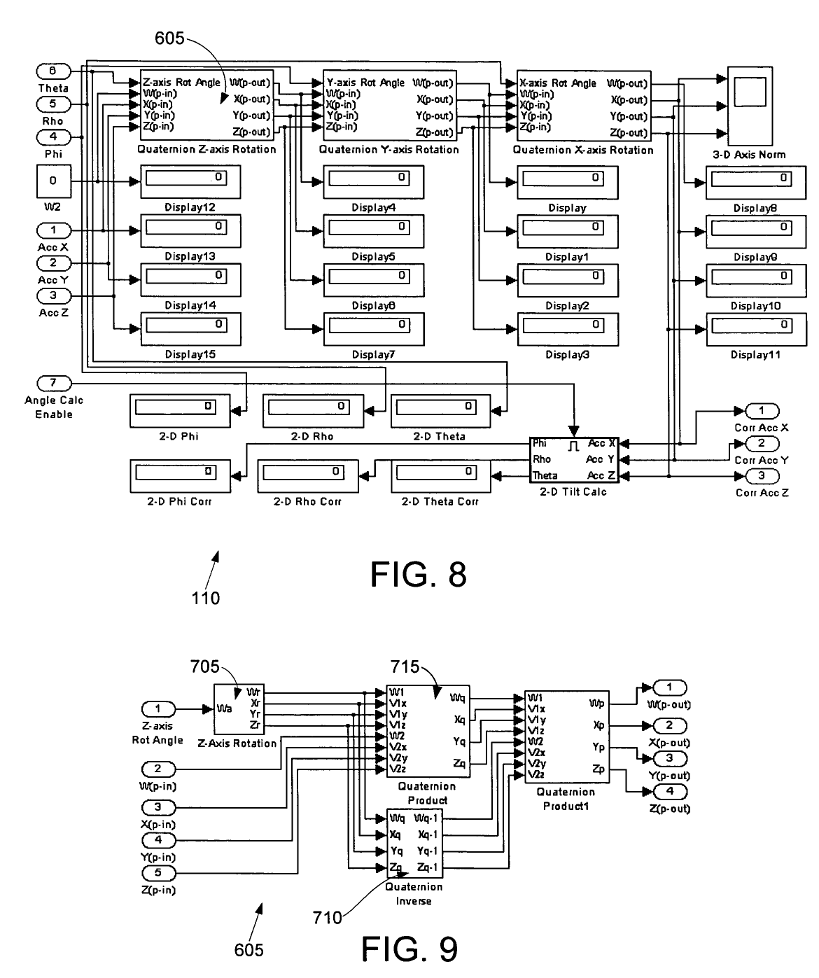

If the DCN module 100 is not perfectly positioned on a plane that is parallel to the x-axis and y-axis and perpendicular to the z-axis, then the accelerometer will provide data as if static acceleration exists. This must be corrected. If not dealt with, it can introduce errors into the 3-D vector constructed for the calculation of vehicle distance coverage, which is described in detail below. FIG. 8 shows a standard quaternion normalization module 110 known to those of ordinary skill in the art to effect pitch, roll and yaw normalization. Normalization is applied first in the z-axis rotation using yaw angle, then in the y-axis rotation using pitch angle and finally in the x-axis rotation using roll angle. This normalizes the 3-D accelerometer data, and is a form of electronic gimballing, as will be appreciated by those of ordinary skill in the art. It will be appreciated by those of ordinary skill in the art that normalization may permit corrections in 3-D such that the DCN module 100 may be placed in any orientation and the DCN module 100 will operate regardless of which axis (X, Y, or Z) is pointed down.

In particular, the method shown in FIG. 8 for rotation normalization is termed quaternion (q), where q is defined as a value in four-dimensional space, q=[w, x, y, z]. Vector q describes a rotation through an angle θ where

$$w = cos ( θ / 2 )$$

and [x, y, z] is the axis of rotation (q=w+ix+jy+kz). To rotate a point, P=Pₓ,P_{y},P_{z}, and P_{rotated}=q.[0,P].q⁻¹.

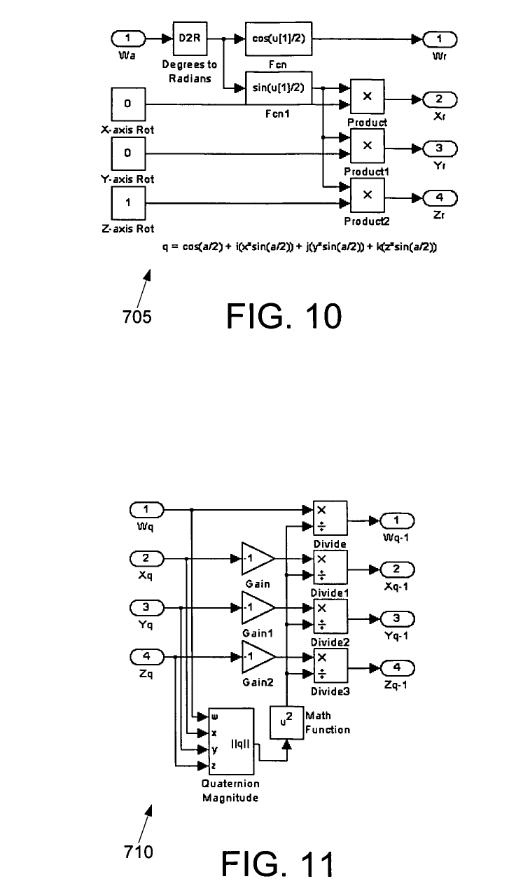

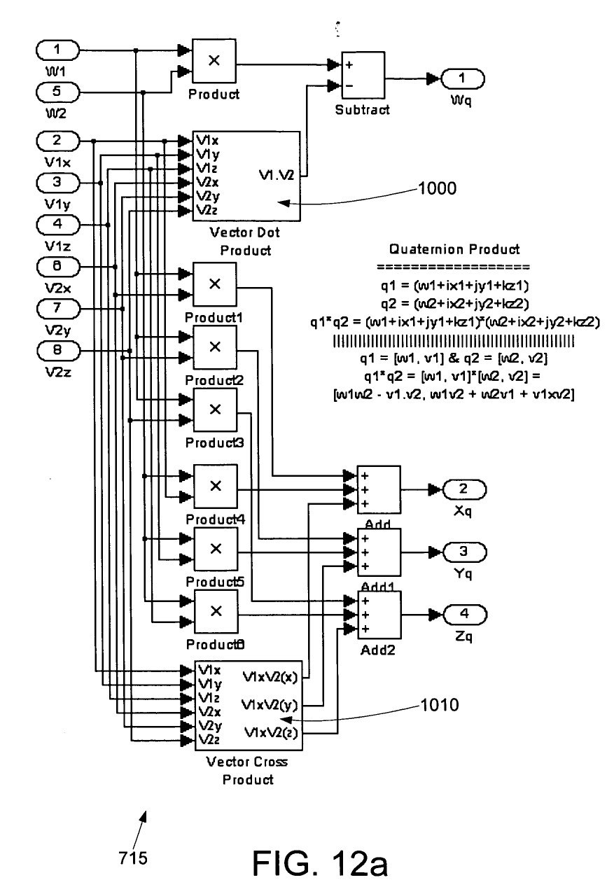

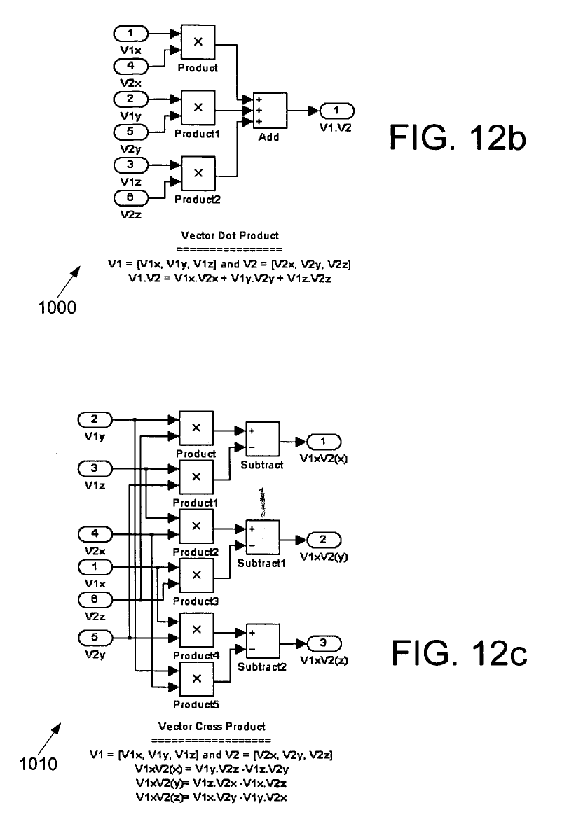

FIG. 9 illustrates the overall implementation for the quaternion z-axis rotation computation module 605. This module 605 includes a quaternion rotation axis module 705, a quaternion inverse module 710, and a quaternion product module 715. FIG. 10 shows an implementation of the quaternion rotation axis module 705, or quaternion vector build up around a specific rotation axis, and FIG. 11 shows a quaternion inverse generation in the quaternion inverse module 710. Multiplication of quaternions is defined as:
q1*q2=[w1, v1]*[w2, v2]=[w1w2−v1∘v2, w1v2+w2v1+v1×v2]
where “∘” implies “vector dot product” and “x” implies “vector cross product”. Implementation of this equation is implemented by the quaternion product module 715 shown in FIG. 12a. Additionally, FIG. 12b shows implementation of the vector dot product 1000 and FIG. 12c shows implementation of the vector cross product 1010, where v1 and v2 are vector quantities.

III. Offset Normalization

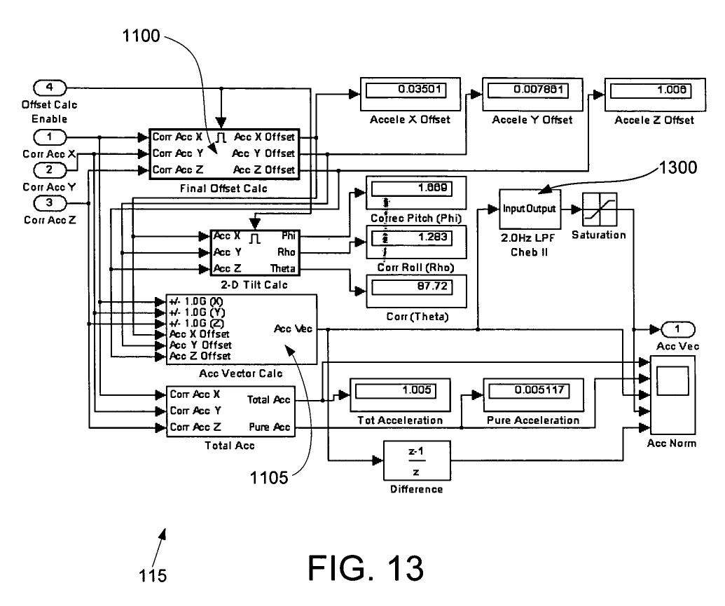

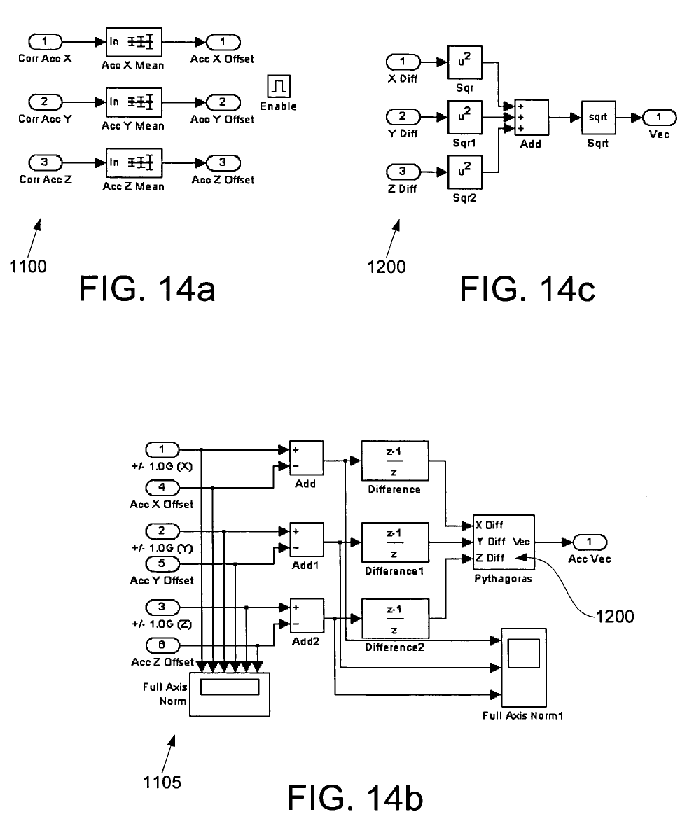

Next, details of the offset normalization module 115 are shown in FIGS. 13-15b. As described above, the offset normalization module 115 calculates final minor error offsets on all 3-D accelerometer axis using the final offset calculation module 1100. These offsets are then subtracted from the rotation normalized data before build of a 3-D acceleration vector (or a 3-D pseudo acceleration vector). In particular, in the offset normalization module 115 shown in FIG. 13, the DCN module still has some residual errors, many of which are due to the specifications of the accelerometer used in conjunction with the DCN module 100. These include errors originating from the following sources: (1) temperature sensitivity at ±3% per ° C. of temperature gradient.; (2) non-linearity in the +90° to −90° range output of the x-, y- and z-axis output; (3) noise density at 350 μg/√4 Hz, and (4) cross-axis sensitivity at +5%. Each of these errors may be accounted for by taking the mean of the electronically gimbaled 3-D accelerometer amplitudes when the vehicle is not moving, as shown in FIG. 14a (i.e. measuring their offsets means when the vehicle is at rest). When the vehicle/pedestrian is at rest, it can only experience static acceleration from the DCN tilt angle and RPM vibration from the vehicle engine. This correction provides the system with a true zero-g leveling on the x- and on the y-axis and a true 1-g leveling on the z-axis. Additionally, as noted above, corrections are applicable and may be interchangeable in 3-D, such that the DCN module 100 can operate regardless of which axis (X, Y, or Z) is pointed down.

As is shown in FIG. 14b, a composite 3-D pseudo acceleration vector is constructed from the electronically gimbaled and offset normalized 3-axis data, which is the “Acc Vector Calc” module 1105 shown in FIG. 14b. The resulting “Acc Vec” signal that is calculated is effectively a 3-D component and length of the acceleration vector. A Low Pass Filter (LPF), such as a 2.0 Hz IIR Chebychev II LPF, filters the “Acc Vec” signal. This is the signal utilized for integration for distance calculation. A heavily filtered version of this signal is utilized for decision making if the vehicle is at rest. FIG. 14c shows the implementation of the Pythagoras module 1200 of the “Acc Vector Calc” module 1105 shown in FIG. 14b.

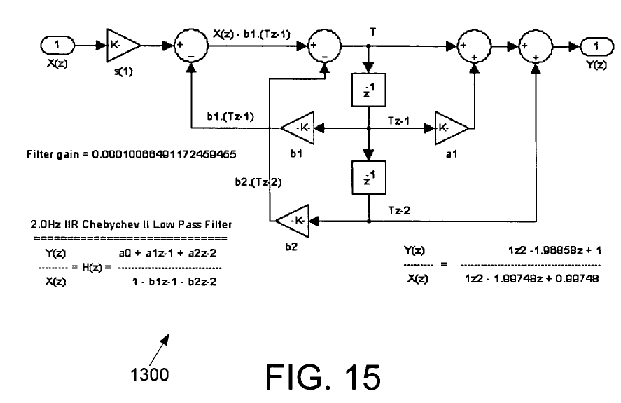

FIG. 15 shows a low pass digital filter definition 1300 for a 2.0 Hz IIR Chebychev filter, which can be used to filter the 3-D pseudo acceleration vector, according to an aspect of the present invention. The digital filter transfer function illustrated in FIG. 15 is

$$\frac{Y ( z )}{X ( z )} = \frac{1 {z}^{2} - 1.96858 z + 1}{1 {z}^{2} - 1.99748 z + 0.99748} .$$

Filtering at this step allows the estimated distance covered to be more stable and minimizes variances due to vehicle and road conditions, such as a bumpy road, harsh shock-absorbers, and the like.

IV. Distance Calculations

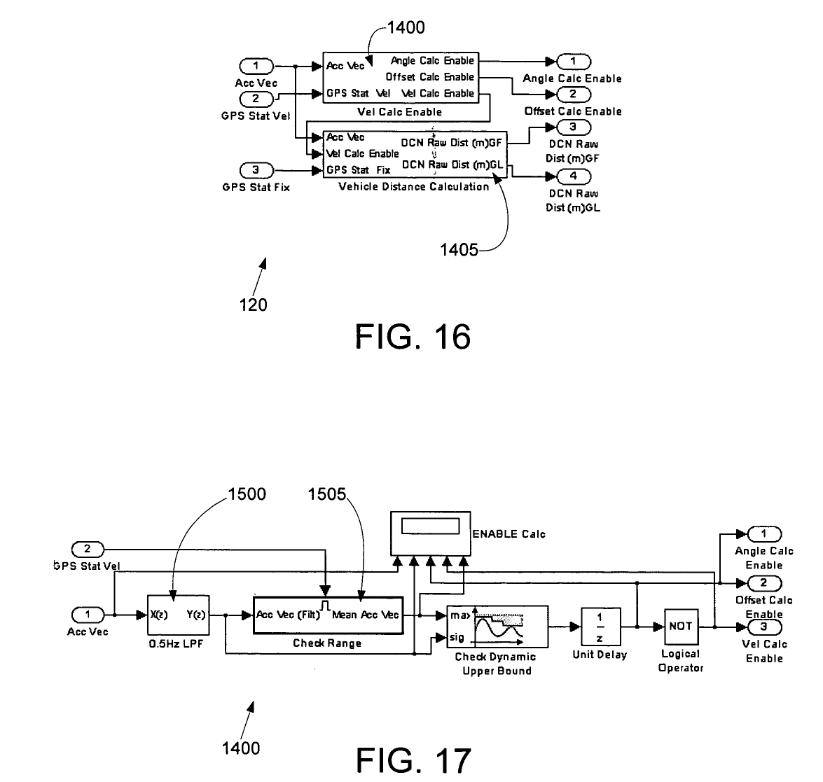

The DCN distance module 120 shown in FIG. 16 performs piece-wise DCN distance calculations during GPS outages. GPS outages are identified by the velocity calculation enable module 1400 shown in FIG. 16. In particular, the DCN distance module 120 makes decisions based on the 3-D pseudo acceleration vector calculated in the last stage. These decisions include: when to integrate the 3-D pseudo acceleration vector using “Vel Calc Enable” decision criteria; when to conduct electronic gimballing using “Angle Calc Enable” decision criteria; and when to conduct offset calculations using “Offset Calc Enable” decision criteria.

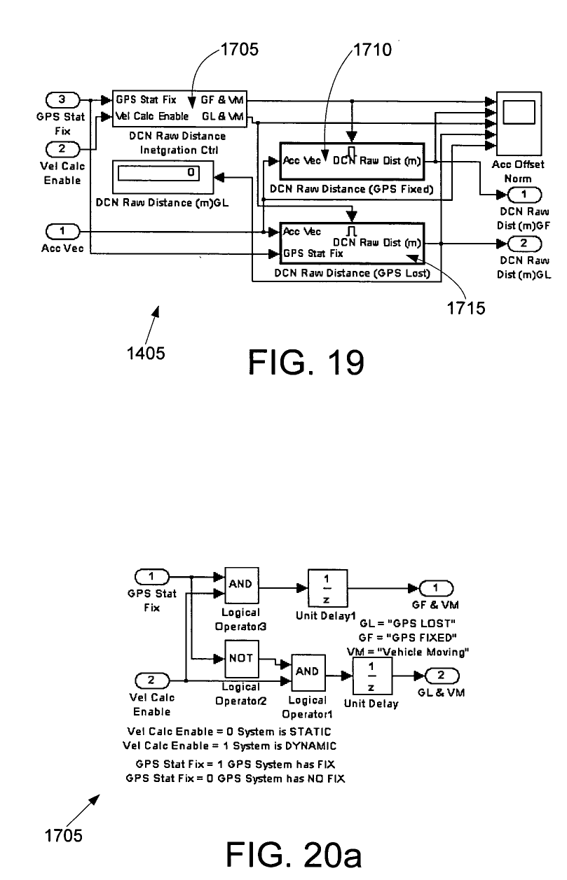

The variable “DCN Raw Dist (m)GF”, shown in FIG. 16 (output 3) is defined as the DCN distance accumulated when GPS is Fixed (i.e., when GPS has a valid Fix), and is calculated by the vehicle distance calculation module 1405 described in greater detail with respect to FIG. 19, below. This is required, as detailed further below, to aid in linear regression calculations. Additionally, the variable “DCN Raw Dist (m)GL”, shown as output 4 of FIG. 16 is defined as the DCN distance accumulated when GPS is Lost (i.e. GPS has no valid fix). This is the measure that is multiplied by the “DCN Multip” (discussed in detail hereinafter) to provide an estimate of the distance covered by the vehicle concerned.

As is shown in FIG. 17, the 3-D pseudo acceleration vector may be filtered using a Butterworth digital filter, such as a 0.5 Hz infinite impulse response Butterworth digital filter. The digital filter transfer function 1500 is stated as

$$\frac{Y ( z )}{X ( z )} = \frac{1 {z}^{2} + 2 z + 1}{1 {z}^{2} - 1.9555 z + 0.9565}$$

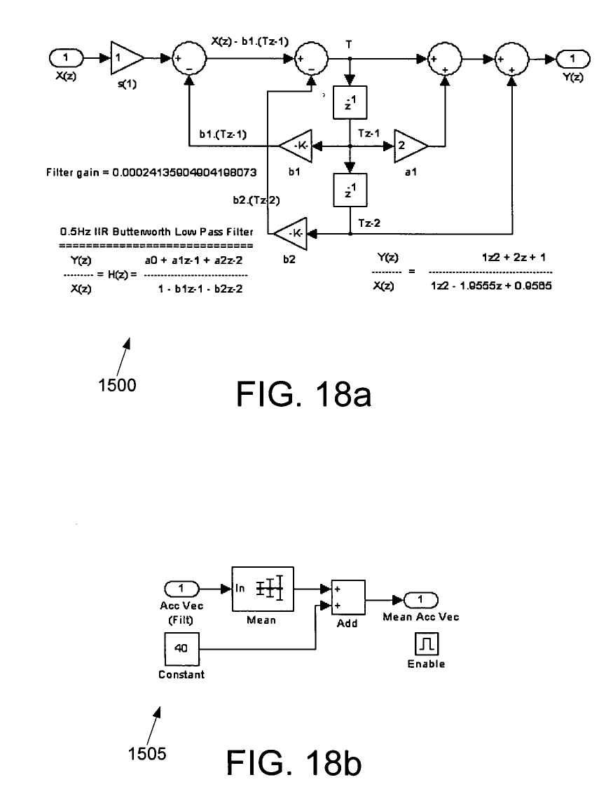

within the model, as is shown in FIG. 18a. This output is passed on to the next check range stage 1505 to calculate this signal's mean plus a minor offset when the vehicle is at rest, as is shown in FIG. 18b. This is conducted automatically with the presence of GPS. From there decisions are made on when to integrate the 3-D pseudo acceleration vector, enable offset and angle calculations.

Next, FIG. 19 shows the vehicle distance calculation module 1405, which integrates the 3-D pseudo acceleration vector to acquire vehicle distance, defined as “DCN Raw Dist(m)GL”, during GPS outage. This is the variable required to multiply with the estimated slope from the linear regression system to give vehicle distance covered during GPS outages. According to one aspect of the invention, this variable may always be reset at the beginning of every GPS outage. FIG. 19 also shows the method for integrating the 3-D pseudo acceleration vector to acquire vehicle distance, defined as “DCN Raw Dist(m)GF”, during GPS availability. This estimate is continuously utilized to calibrate the DCN system when GPS is available. The decision to integrate or not to integrate lies within the “Vel Calc Enable” signal making the decision if the vehicle is at rest or not and acting accordingly. According to one aspect of the invention, this variable is never reset at the beginning of every GPS outage.

It will be appreciated that the “DCN Raw Distance Integration Ctrl” module 1705 shown in FIG. 19 has two outputs. These are “GF & VM”, which decide when GPS is fixed and vehicle is in motion to allow continuous accumulation of “DCN Raw Distance (m)GF” and aid linear regression to calculate slope estimates; and “GL & VM”, which decide when GPS is lost and vehicle is in motion to allow continuous accumulation of “DCN Raw Distance (m)GL” and aid vehicle distance estimates using linear regression slope estimates.

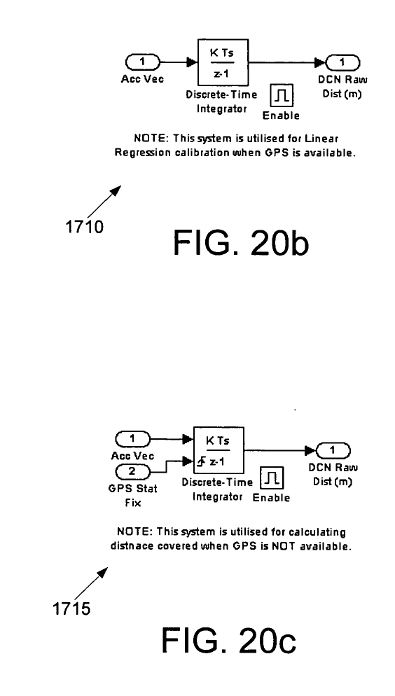

Next, FIGS. 20a-c show the internal definitions of the three modules 1705, 1710, 1715 shown in FIG. 19. In particular, FIG. 20a shows the “DCN Raw Distance Integration Ctrl” module 1705 that decides when to allow integration of both variables “DCN Raw Dist (m) GF” and “DCN Raw Dist (m) GL” depending on GPS fix status and vehicle dynamics status. Additionally, FIG. 20b shows the DCN Distance Calculation during GPS Fix module 1710, and FIG. 20c shows the DCN Distance Calculation during GPS Outage module 1715.

V. DCN Multiplier Calibration

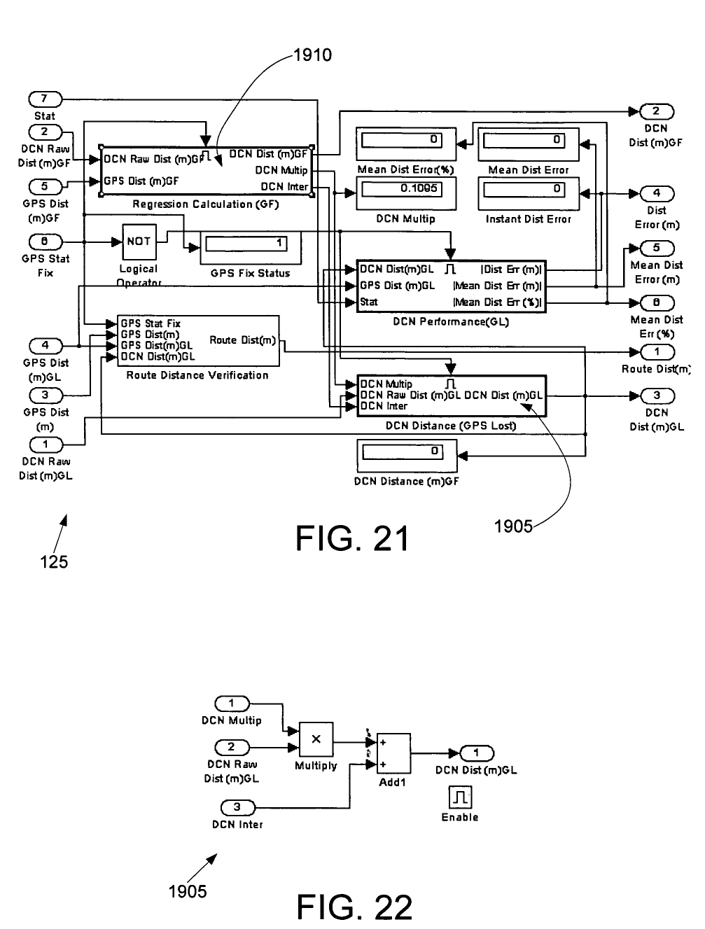

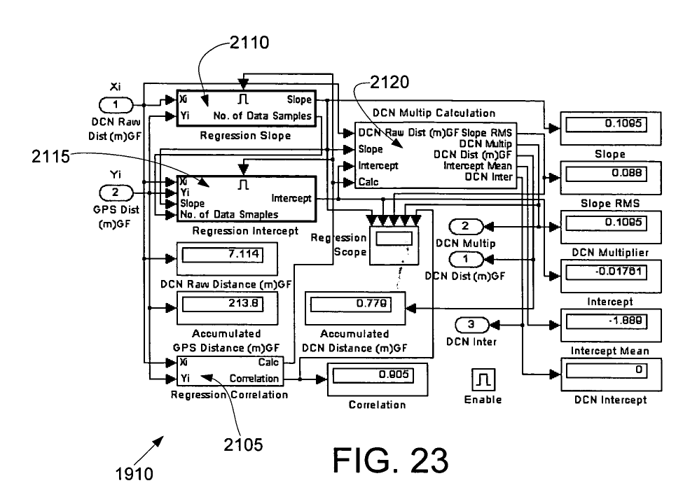

As shown in the DCN Multiplier Calibration module 125 of FIG. 21, while GPS is available, linear regression is continuously calculated between estimated GPS distance covered against estimated DCN distance covered. This operation allows the fitting of a straight line equation (i.e. y=mx+b), using x-data as the “DCN Raw Dist(m)GF” and y-data as “GPS Dist(m)GF”, thus allowing calculating estimates of the “slope—DCN Multip” and “Intercept—DCN Inter”, both variables defined in the Regression Calculation (GF) module 1910, the particulars of which are illustrated in FIG. 23. When GPS is available, the DCN multiplier calibration module 125 is continuously calibrating the DCN module 100 by continuously estimating the slope (i.e. minimizing the least squares estimates) and intercept. On the other hand, when GPS outage is experienced, the “regression slope—DCN Multip” is frozen. Meanwhile, the “DCN Raw Dist (m)GL”, shown in the DCN Distance (GPS Lost) module 1905 shown in detail in FIG. 22 starts being accumulated and multiplied by the “DCN Multip”, thereby providing a vehicle distance coverage estimate, “DCN Dist (m)GL”, during GPS outage.

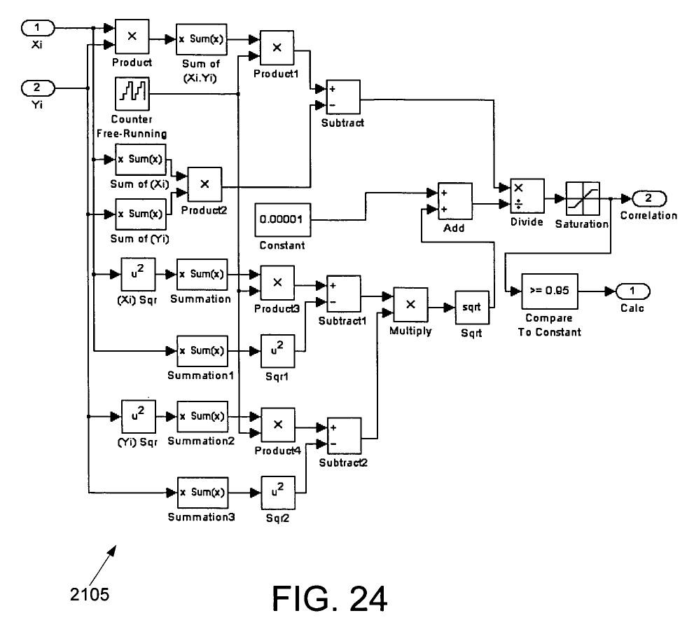

DCN Multiplier Generation using a linear regression calculation is executed in the Regression Calculation (GF) module 1910, including regression slope and regression intercept in module form. The linear regression equations are defined in more detail below. FIG. 24 shows the calculation of the regression correlation coefficient by the regression correlation module 2105, which is also required to compute the linear regression calculation. This effectively gives an estimate of how correlated are the GPS data and DCN data when GPS is fixed. Correlation coefficients have a range of 0 (no correlation between data sets) to 1 (maximum correlation between data sets). The DCN module 100 is primed to allow slope and intercept computations when the correlation coefficient is higher that 0.94. Although coefficient may be altered, this coefficient permits only good quality data to form of the slope and intercept estimates.

The linear regression equations for slope (m) and intercept (b) are implemented by the regression slope module 2110 and regression intercept module 2115, respectively:

$$m = \frac{n {\sum }_{i = 1}^{n} ( {x}_{i} {y}_{i} ) - {\sum }_{i = 1}^{n} {x}_{i} {\sum }_{i = 1}^{n} {y}_{i}}{n {\sum }_{i = 1}^{n} ( {x}_{i}^{2} ) - {( {\sum }_{i = 1}^{n} {x}_{i} )}^{2}}$$

$$b = \frac{{\sum }_{i = 1}^{n} {y}_{i} - m {\sum }_{i = 1}^{n} {x}_{i}}{n}$$

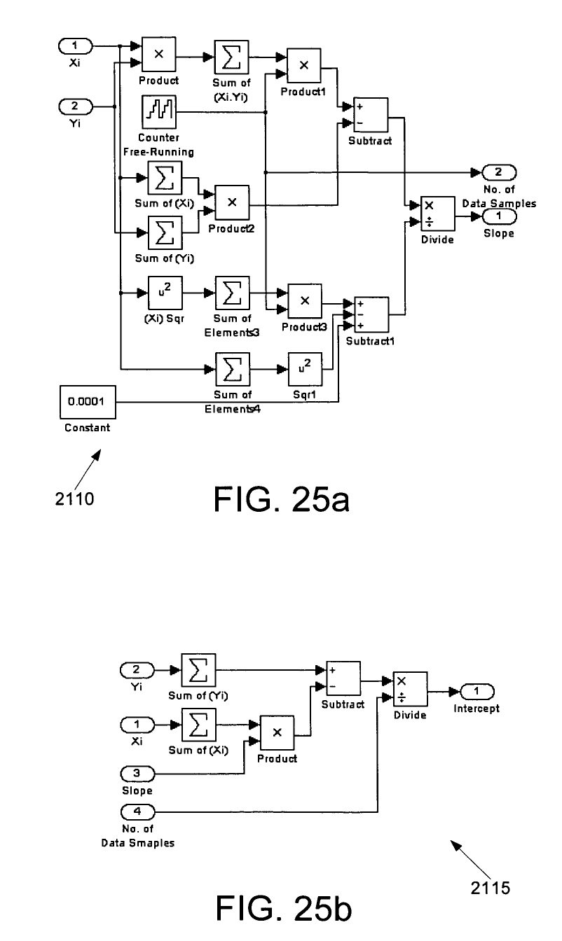

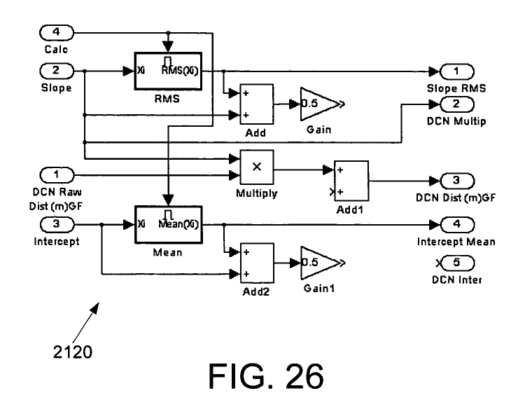

Mathematical implementations of the slope and intercept equations are shown in FIGS. 25a and 25b, respectively. As is illustrated by the DCN Multip calculation module 2120 in FIG. 26, “DCN Multip” is a direct value of the calculated regression slope. According to another aspect of the invention, Root-Mean-Square (RMS) of the regression slope may alternatively be used. When GPS is available, it is preferred that there is a 3-D fix with a minimum of 5 satellites and PDOP<3, to be able to utilise its distance estimates.

VI. Magnetometer Calibration

The magnetometer normalization module 130 performs a similar function to the accelerometer normalization module 105, and is the used by the DCN to understand what voltage readings are received from a magnetometer when each of the 3 axes are subjected to a North heading. Illustrative measurements are provided below to illustrate their incorporation into the magnetometer normalization module 130, considered next.

X-Magnetometer range=5.92V (max); 4.29V (min)

Y-Magnetometer range=5.83V (max); 4.20V (min)

Z-Magnetometer range=6.43V (max); 6.32V (min)

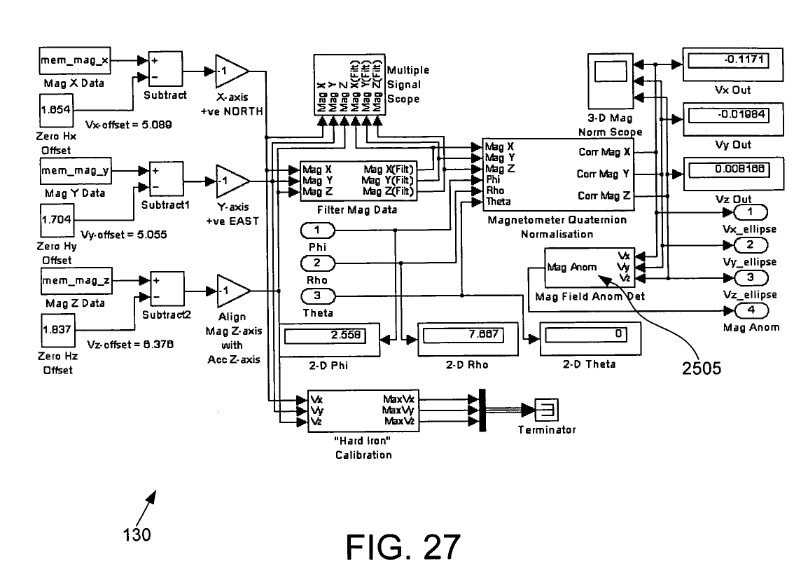

As shown in FIG. 27, the magnetometer normalization model 130 takes in real magnetometer data from the x-, y- and z-axis. This data is initially presented in voltage and is zero offset in the 3-axes to normalize against the earth magnetic field power. This step is conducted to all 3-D data. As in the case of the accelerometer normalization, magnetometer tilt correction is also applied. The pitch, roll and yaw angle calculated from the accelerometer stage, are utilized to correct for magnetometer system tilt using quaternions. The quaternion normalization module 110 has already been described above with respect to the accelerometer, and functions in a like manner as previously described.

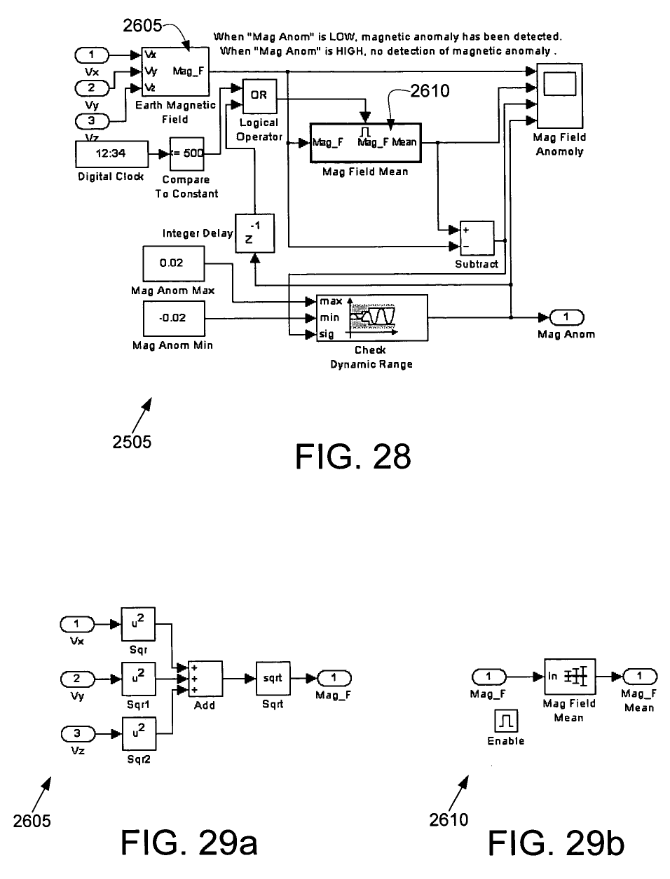

The magnetic field anomaly detection module 2505 of FIG. 28 is operable to permit detection of magnetic anomalies. Magnetic anomalies exist when the earth's magnetic field, provided by the earth magnetic field module 2605, is disturbed by external magnetic forces such as steel (“Hard Iron”) or ferrous material (“Soft Iron”). If a 360° magnetometer circle is executed, a perfect circle with a radius equivalent to the earth's magnetic field power centered on the origin is plotted (assuming no external magnetic disturbances). If the total earth's magnetic field power mean, as determined by the magnetic field mean module 2610 of FIG. 29b, is monitored and compared against the instantaneous total earth's magnetic field, then any minor magnetic disturbance can be detected. This forces the system to not update its heading information when magnetic anomalies are detected.

VII. Full Magnetometer Calibration

It will be appreciated that only errors caused by deterministic interference sources (e.g. a compass in a vehicle) can be compensated versus non-deterministic interference sources (e.g. field of another vehicle passing by). Therefore, all calibration activity should be conducted when the system is implemented into its target space. A system rotation of 360° is required to achieve full “hard iron” and “soft iron” calibration and subsequent elimination.

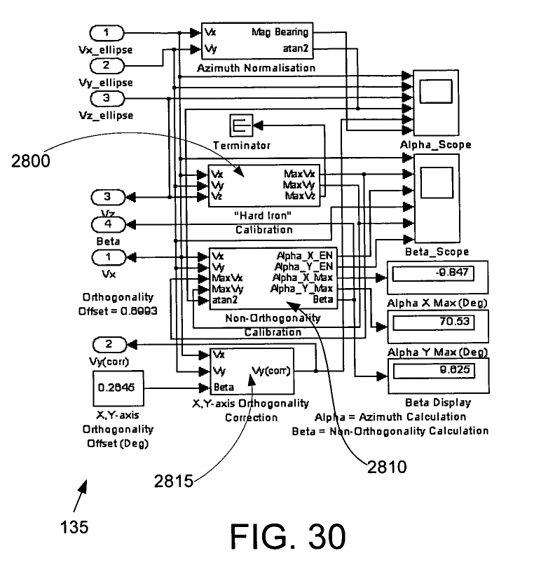

The present invention permits accounting for three types of magnetic disturbances, including “hard iron” effects, “soft iron” effects, and X-/Y-axis non-orthogonality effects. These are accounted for by the full magnetometer calibration module 135, illustrated in FIG. 30. “Hard Iron” effects exist from magnetic disturbances caused by a magnetized object. This creates a circle offset from the origin but still retains its circular shape. “Soft Iron” effects exist from magnetic disturbances caused by ferrous material. This creates a circle offset from the origin and distorts the circle to a more elliptical shape. Finally, X-/Y-axis Non-Orthogonality effects exist from less-than-perfect semiconductor fabrication processes. This creates a 90°+ offset angle between the magnetometer X- and Y-axis.

a. “Hard Iron” Calibration

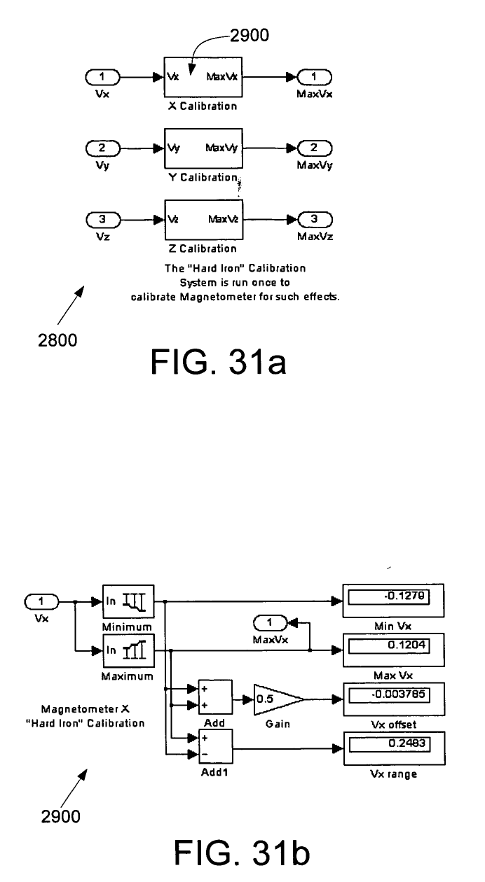

Two measurements should be carried out with the compass at the same location, but at a heading difference of 180° (e.g. in a target vehicle application, the first reading would be taken upon initiation of calibration and a second point would be taken at the conclusion of a U-turn). This will provide a maximum and a minimum in all 3 axes. Averaging these readings (i.e. (max.+min.)/2)) provides the x-, y- and z-offsets. Also, differencing the maximum from the minimum gives the x-, y- and z-ranges. “Hard Iron” calibration is illustrated by the hard iron calibration modules 2800, 2900 shown in FIGS. 31a-b. These offsets can then be subtracted from the actual magnetometer data injected into the DCN system to provide “Hard Iron” magnetic-disturbance-free data, FIG. 27, (Zero Hx-, Hy- and Hz-offset data).

b. “Soft Iron” Calibration

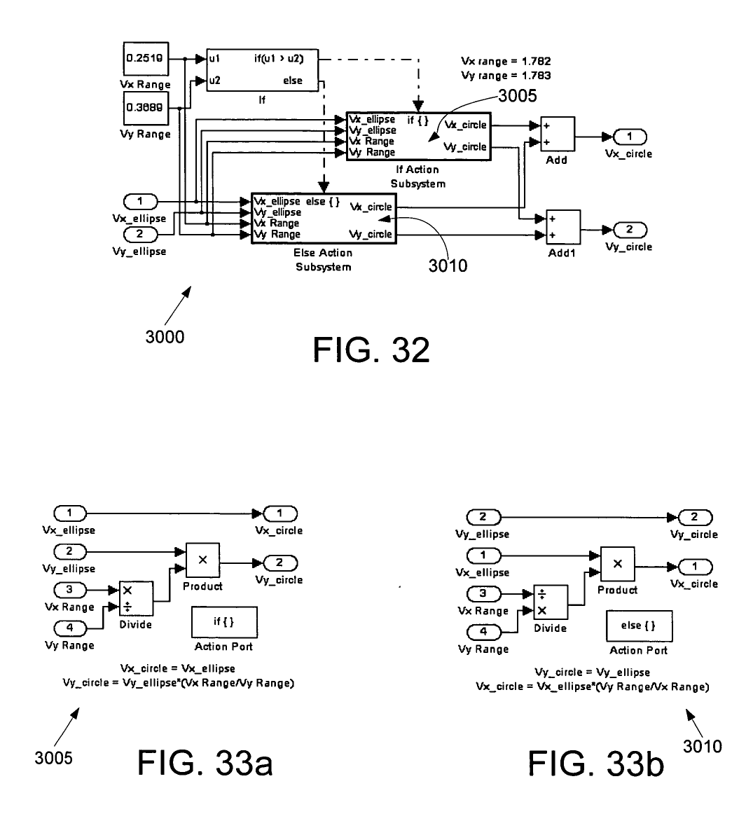

Once a full rotation calibration has been conducted, soft iron effects can be eliminated using the soft iron calibration method executed in the soft iron calibration module 3000 of FIG. 32 by computing the x-, y- and z-ranges as discussed above. Thus, if (x-range>y-range) then x-circle=x-ellipse and y-circle=y-ellipse*(x-range/y-range); else if (x-range<y-range) then x-circle=x-ellipse*(y-range/x-range) and y-circle=y-ellipse. The above ‘if’ statement definition 3005 is shown in FIG. 33a, and the ‘else’ definition 3010 is shown in FIG. 33b. Utilizing the offsets calculated for the “Hard Iron” effects and the ranges calculated in the “Soft Iron” effects will move the center of the circle back to the origin and the ranges are used to match the gain so the graph will become a circle from the original ellipse.

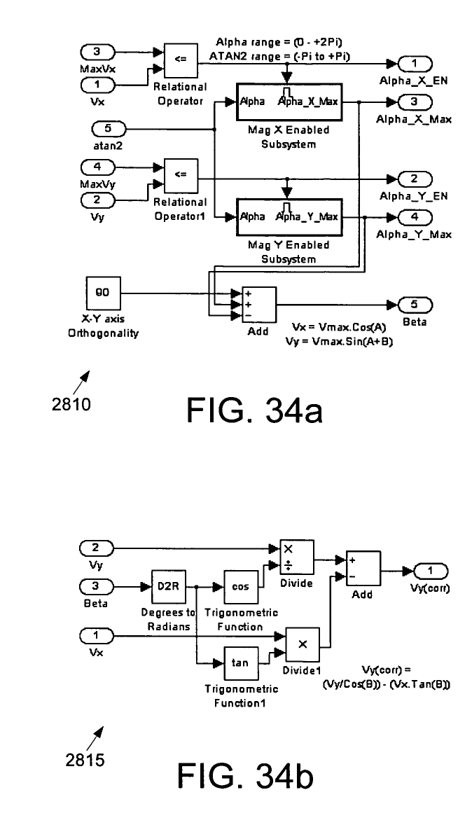

Once a system completes a full circle, then a sine wave is plotted by one axis and a cosine wave is plotted by the other axis. The angular separation between the two axes has to be exactly 90° at the maximums. If not then any error residual is the non-orthogonal (β) factor to be compensated for. In practice the displacement of two magnetic field sensors will deviate by an angle β from the desired orthogonality (90°) due to mounting tolerances. This deviation causes an error in the compass reading, which is a periodic function of the azimuth. The maximum error is approximately equal to the non-orthogonality β. If a higher accuracy is desired, β should be compensated. If the compass is rotated with respect to the earth's field, then the phase shift between x- and y-axis is 90°±β. Having determined β, the error can be eliminated mathematically. In particular, assuming that the SCU delivers the signals: V_{y}=Vₘₐₓ.sin(α+β) and Vₓ=Vₘₐₓ.cos(α) where α is the azimuth that a corrected signal: V_{y(corrected)}=Vₘₐₓ.sin(α) is desired. Thus, the corrected V_{y} in terms of β is: V_{y(corrected)}=(V_{y}/cos(β))−(Vₓ.tan(β)). FIG. 34a details the non-orthogonality angle calculation implemented by the non-orthogonality calibration module 2810, and FIG. 34b shows the non-orthogonality compensation calculation implemented by the orthogonality correction module 2815.

VIII. Magnetometer Bearing Normalisation

Because high accuracy directional information is desired, e.g., 1° degree or better, a microcontroller can be used for evaluation of the following equation: a=arctan 2(V_{y}/Vₓ). It is assumed, that Vₓ and V_{y} are corrected with respect to offset, sensitivity difference and non-orthogonality. The arctan2 function is uniquely defined only in the angular range of −x/2 to +x/2 with 0° being at East. Thus to calculate the azimuth a (ranges 0° to 360°), the following equations are implemented:
If V≧0 and V_{y}≧0 then α=(90°−(arctan2(V_{y}/Vₓ)).(180/π) (α is between 0° and 90°)
Elseif Vₓ≧0 and V_{y}<0 then α(90°+(−arctan2(V_{y}/Vₓ)).(180/π) (α is between 91° and 180°)
Elseif Vₓ<0 and V_{y}<0 then α=(90°+(−arctan2(V_{y}/Vₓ)).(180/π) (α is between 181° and 270°)
Else Vₓ<0 and V_{y}≧0 then α=(450°−(arctan2(V_{y}/Vₓ)).(180/π) (αis between 271° and 360°)

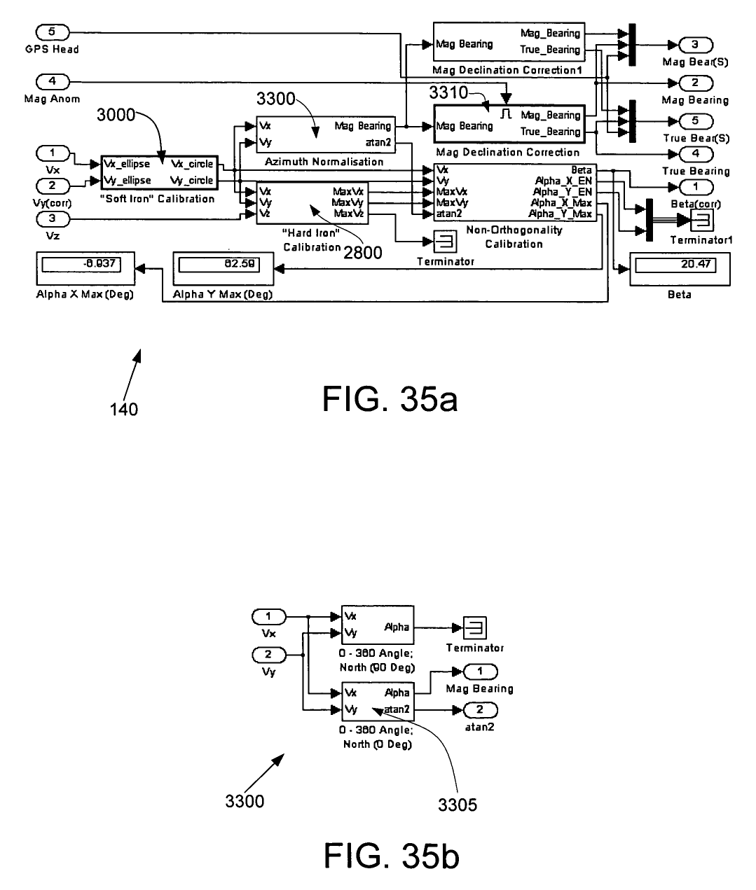

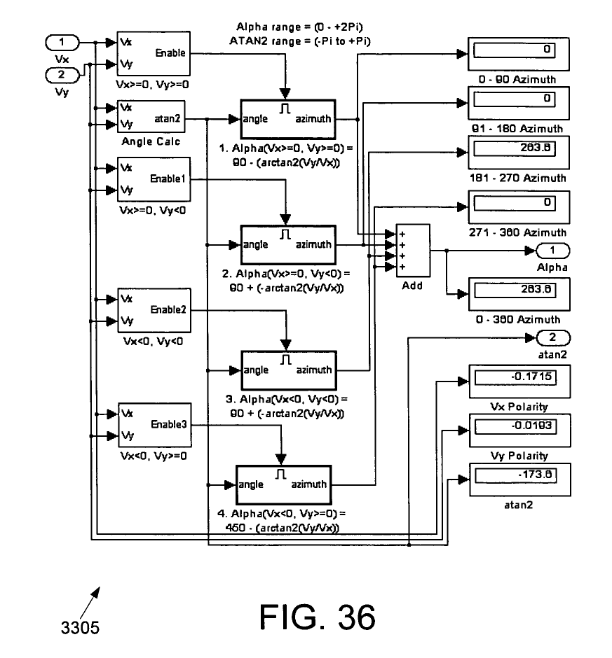

The above equations are based on the convention, that the azimuth is counted clockwise from North to the heading direction. This system establishes North @0°/360°, East @ 90° and South @ 180° and West @ 270°. FIG. 35a shows the azimuth normalization calculation by the magnetometer bearing normalization module 140, and FIG. 35b shows the soft iron “atan2” calculation by the soft iron calibration module 3300. Additionally, FIG. 36 shows the azimuth angular definition 3305 used by the soft iron calibration module 3300 to calculated the soft iron “atan2”.

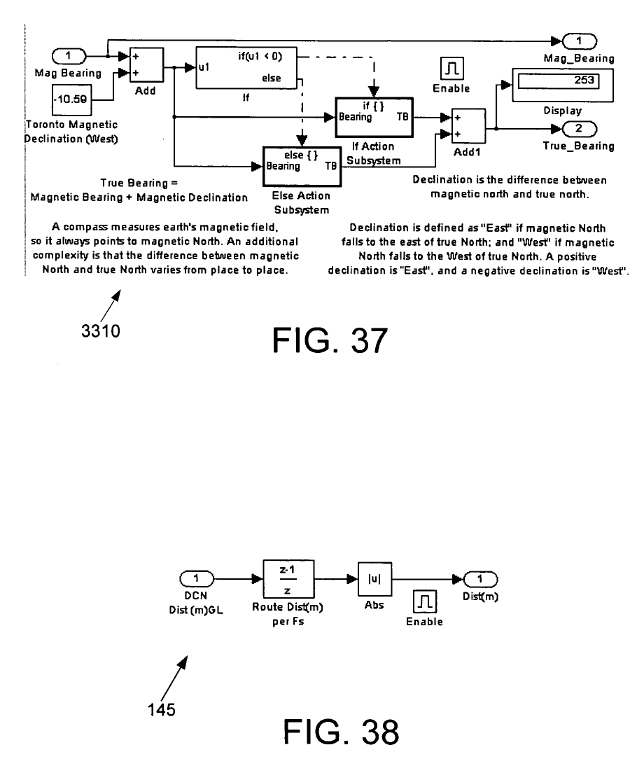

It will be appreciated that measuring azimuth with a compass indicates the heading direction relative to magnetic north. However, the heading direction relative to geographic or true north is required in order to allow vehicle or pedestrian navigation by means of a map. As the magnetic and geographic poles of the earth do not coincide, the direction of true north and magnetic north can deviate significantly from each other. This deviation is referred to as declination. Declination is defined as angle from true north to magnetic north. The value of declination varies with the position on earth and can be to the east or to the west. East declination means that the magnetic north direction indicated by the compass is east of true north. Declination also varies over long periods of time, therefore only updated declination data should be used for compensation. In order to compensate for true north, the declination angle at the actual location has to be added to or subtracted from the azimuth reading of the compass. The appropriate operation depends on whether the declination is to the east or to the west. Correction of magnetic declination is executed by the magnetic declination correction module 3310 shown in FIG. 37.

The magnetic declination correction module shown in FIG. 37 takes in a declination reading and adjusts the magnetometer heading by simply adding its declination to the non-corrected magnetometer reading. The National Geophysical Data Center (NGDC) supplies World Magnetic World models as well as C++ program that allow calculation of Declination anywhere on earth. This allows the target system to cope with local magnetic field anomalies with as much as 10° to 15° variations. In the illustrative example of the DCN module 100, magnetic declination is corrected as if the DCN module 100 is located in Toronto.

IX. DCN Distance

The combined DCN/GPS distance module 145 shown in FIG. 38 provides distance covered on a second by second basis to the latitude/longitude given radial and distance module 150. When GPS experiences an outage, calculations can be conducted using initial latitude and longitude (when GPS was available), a distance estimate provisioned by the accelerometer and a direction estimate provisioned by the magnetometer. A destination point {lat_{d}, lon_{d}} is a distance d out on the a radial from the source point {latₛ, lonₛ} if:
lat_{d}=sin⁻¹(sin(latₛ)*cos(d)+cos(latₛ)*sin(d)*cos(α))
dlon=tan 2⁻¹(sin(α)*sin(d)*cos(latₛ), cos(d)−sin(latₛ)*sin(lat_{d}))
lon_{d}=mod(lonₛ+dlon+π,2π)−π

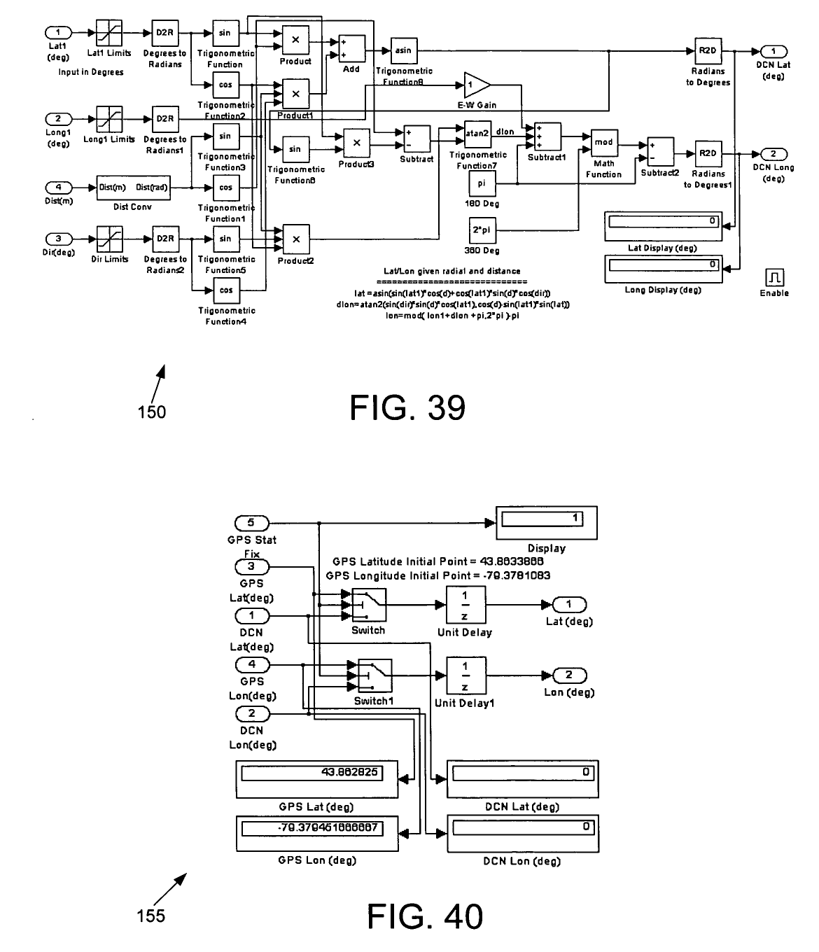

A nautical mile is a unit of distance that is equal to one minute ( 1/60 of a degree) of longitude. It is also defined as a unit of distance equivalent to one minute of the great circle of the Earth (=1,852 meters). Converting nautical miles to statute miles simply requires using the international measure of one nautical mile, or 1852 meters. FIG. 39 shows the definition implemented by the latitude/longitude given radial and distance module 150.

X. GPS/DCN Initial Location

The GPS/DCN initial location module 155 shown in FIG. 40 may be utilized whenever GPS experiences an outage. It allows the DCN system to initialize itself with the last known good GPS fix location before the experienced outage. The DCN system then takes over the generation of latitude/longitude offset from that original location and computes subsequent locations till GPS is back online with another good known fix.

According to another aspect of the invention, a map matching input may be provided as an input to the DCN module as another sensor. Therefore, the DCN module may utilize map matching information along with the location information, determined as described above, to determine location. Additionally, although described herein with respect to providing continuous navigation only when GPS is not available, it will be appreciated the methods described herein may be implemented without the use of GPS. For instance, continuous navigation may be provided from a discrete location that is not identified to the DCN module by GPS. According to yet another aspect of the invention, a windowing function may be used in the regression.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of providing continuous navigation, comprising:
identifying the last known location of an object using, at least in part, a GPS signal; and
estimating a distance travelled by the object from the last known location using only information received from an accelerometer located on a device positioned on the object, wherein estimating the distance is based on a single integration of a three dimensional acceleration vector derived from the accelerometer,
wherein the device is positioned on the object, but receives no other electrical or mechanical inputs from the object.

2. The method of claim 1, wherein the object is a vehicle or a pedestrian.

3. The method of claim 1, further comprising determining a next location of the object based on information received from the accelerometer and a magnetometer of the device.

4. The method of claim 1, further comprising estimating a heading of the object based on a magnetometer located on the device positioned on the object.

5. The method of claim 1, further comprising conducting tilt measurements on the accelerometer when the object is not moving.

6. The method of claim 1, further comprising normalizing three dimensional data received from the accelerometer, prior to estimating the distance travelled by the object, to generate normalized three dimensional data.

7. The method of claim 6, wherein normalizing the three dimensional data received from the accelerometer comprises using quaternion rotation calculations to generate the normalized three dimensional data.

8. The method of claim 6, wherein normalizing the three dimensional data received from the accelerometer comprises using tilt measurements of the accelerometer to generate the normalized three dimensional data.

9. The method of claim 6, wherein the three dimensional acceleration vector derived from the accelerometer is generated from the normalized three dimensional data.

10. The method of claim 1, further comprising filtering the three dimensional acceleration vector derived from the accelerometer prior to the single integration of a three dimensional acceleration vector.

11. The method of claim 1, further comprising determining if the object is moving by filtering the three dimensional acceleration vector.

12. The method of claim 1, further comprising determining whether global positioning system (GPS) signals are available subsequent to estimating a distance travelled by the object.

13. The method of claim 12, further comprising calculating regression, when GPS signals are available, between the estimated distance travelled by the object and an estimated GPS distance travelled determined from the GPS signals.

14. A computer-readable medium having stored thereon computer-executable instructions for performing the method of claim 1.

15. A device positioned on an object, for providing continuous navigation, comprising:
an accelerometer; and
at least one computer program operable to:
identify the last known location of the object using, at least in part, a GPS signal; and
estimate a distance travelled by the object from the last known location using only information received from the accelerometer, wherein estimating the distance is based on a single integration of a three dimensional acceleration vector derived from the accelerometer,
wherein the device is positioned on the object, but receives no other electrical or mechanical inputs from the object.

16. The device of claim 15, wherein the object is a vehicle or a pedestrian.

17. The device of claim 15, further comprising a magnetometer, and wherein the at least one computer program is further operable to determine a next location of the object based on information received from the accelerometer and a magnetometer of the device.

18. The device of claim 15, further comprising a magnetometer, and wherein the at least one computer program is further operable to estimate a heading of the object.

19. The device of claim 15, wherein the at least one computer program is further operable to conduct tilt measurements on the accelerometer when the object is not moving.

20. The device of claim 15, wherein the at least one computer program is further operable to normalize three dimensional data received from the accelerometer, prior to estimating the distance travelled by the object, to generate normalized three dimensional data.

21. The device of claim 20, wherein the at least one computer program is further operable to normalize the three dimensional data using quaternion rotation calculations.

22. The device of claim 20, wherein the at least one computer program is further operable to normalize the three dimensional data using tilt measurements of the accelerometer.

23. The device of claim 20, wherein the at least one computer program is further operable to generate the three dimensional acceleration vector, derived from the accelerometer, from the normalized three dimensional data.

24. The device of claim 15, wherein the at least one computer program is further operable to filter the three dimensional acceleration vector derived from the accelerometer prior to the single integration of a three dimensional acceleration vector.

25. The device of claim 15, wherein the at least one computer program is further operable to determine if the object is moving by filtering the three dimensional acceleration vector.

26. The device of claim 15, wherein the at least one computer program is further operable to determine whether global positioning system (GPS) signals are available subsequent to estimating a distance travelled by the object.

27. The device of claim 26, wherein the at least one computer program is further operable to calculate regression, when GPS signals are available, between the estimated distance travelled by the object and an estimated GPS distance travelled determined from the GPS signals.
